(19) United States
(12) Patent Application Publication
(10) Pub. No.: US 2026/0039639 A1
(43) Pub. Date: Feb. 5, 2026

(54) COMPREHENSIVE TELEMETRY DATA MANAGEMENT IN CLUSTER NETWORKS WITH DYNAMIC DATASET REGISTRATION AND PROCESSING

(71) Applicant: Dell Products L.P., Round Rock, TX (US)

(72) Inventors: Supriya Kannery, Bengaluru (IN); Rajat Badola, Bengaluru (IN); Philip Shilane, Newtown, PA (US); Bhimsen Bhanjois, Fremont, CA (US)

(21) Appl. No.: 18/791,315

(22) Filed: Jul. 31, 2024

(51) Int. Cl. H04L 9/40; G06Q 30/018; H04L 67/133; H04L 67/55

(52) U.S. Cl. CPC H04L 63/08; G06Q 30/018; H04L 67/133; H04L 67/55

(57) ABSTRACT

A telemetry processing system in a cluster network generates telemetry data from producers and formats it into a structured format for storage and transmission to subscribed consumers. The system implements an open telemetry system (OTEL) that is opaque regarding transport of data to the subscribers and includes access-based and security compliance controls. The system accommodates dynamic frequency requests by mapping data sets to collectors to optimize data collection and sharing. For large-scale systems, certain producer and consumer controls are provided. It also processes golden signals can be used to implement certain self-healing and debugging processes. For streaming data certain optimization features are used for storage and network bandwidth usage.

### TECHNICAL FIELD

Embodiments are directed to distributed networks, and more specifically to telemetry data management with dynamic registration and processing of telemetry datasets.

### BACKGROUND

A distributed (or cluster) network runs a filesystem in which data is spread across multiple storage devices as may be provided in a cluster of nodes. Cluster networks (or cluster systems) represent a scale-out solution to single node systems by providing networked computers that work together so that they essentially form a single system. Each computer forms a node in the system and runs its own instance of an operating system. The cluster itself has each node set to perform the same task that is controlled and scheduled by software. In this type of network, the file system is shared by being simultaneously mounted on multiple servers. This type of distributed filesystem can present a global namespace to clients (nodes) in a cluster accessing the data so that files appear to be in the same central location. They are typically very large and may contain many hundreds of thousands or even many millions of files, as well as services (applications) that use and produce data.

The Santorini filesystem represents a type of cluster system that stores the file system metadata on a distributed key value store and the file data on object store. The file/namespace metadata can be accessed by any front end node, and any file can be opened for read/write operations by any front-end node.

Because of their extensive scale and complex component features, cluster systems are typically provided by vendors and installed for use by customers (users). Proper system administration requires the collection and transmission of relevant data to users from applications, nodes, and product vendors within the system. Such data is referred to as “telemetry” data and includes information about the running system that is generated periodically and that should be stored and transferred to the various clients as needed.

Present telemetry architectures are typically fixed with respect to the type and amount of data that is available for users and clients. As distributed systems evolve and become more complex, it is increasingly important to provide flexible telemetry mechanisms for storage systems. Present systems are not flexible and dynamic enough to add new metric datasets, or data producers or consumers. Nor do they implement effective security and access controls, or efficiently process both discrete and streaming telemetry data.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell and EMC are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram illustrating a distributed system implementing flexible telemetry processing for cluster networks, under some embodiments.

FIG. 2 is a diagram illustrating telemetry processing components and features for the system of FIG. 1, under some embodiments.

FIG. 3 illustrates an example of some services related to the data path running in Santorini cluster network, under some embodiments.

FIG. 4 illustrates an advanced telemetry architecture for Kubernetes-based storage systems, under some embodiments.

FIG. 5 is a table that lists some example consumers and datasets for the system of FIG. 4, under some embodiments.

FIG. 6 is a flowchart that illustrates a process of implementing a subscription-based telemetry architecture for Kubernetes-based networks, under some embodiments.

FIG. 7A illustrates an example user subscription table, under some embodiments.

FIG. 7B illustrates an particular example transport target table for FIG. 7A.

FIG. 8 illustrates a table storing a dataset for a pod, under an example embodiment.

FIG. 9 illustrates a telemetry data pipeline, under some embodiments.

FIG. 10 illustrates an example RBAC hierarchy used for the RBAC-based dynamic catalog, under some embodiments.

FIG. 11 illustrates a telemetry data processing system implementing an RBAC-based dynamic catalog, under some embodiments.

FIG. 12 is a flowchart that illustrates a method of allowing access to telemetry data through an RBAC-based dynamic catalog, under some embodiments.

FIG. 13 illustrates a telemetry data processing system implementing dynamic registration of new metrics, under some embodiments.

FIG. 14A is a flowchart that illustrates a method of dynamically registering new telemetry datasets, under some embodiments.

FIG. 14B is a flowchart that illustrates a method of dynamically registering telemetry datasets for a short duration, under some embodiments.

FIG. 15 illustrates a telemetry a data processing system dynamically allocating RBAC rules for new metric data sets, under some embodiments.

FIG. 16 is a flowchart illustrating a process of dynamically allocating RBAC rules for new metric data sets, under some embodiments.

FIG. 17 illustrates a telemetry data processing system implementing automatic security compliance checks, under some embodiments.

FIG. 18 is a flowchart that illustrates a method of implementing automatic security compliance checks, under some embodiments.

FIG. 19 is a flowchart that illustrates a method of controlling telemetry producers when registering new metrics, under some embodiments.

FIG. 20 is a flowchart that illustrates a method of controlling telemetry consumers when registering new metrics, under some embodiments.

FIG. 21 illustrates a Kubernetes-based telemetry system processing golden signals, under some embodiments.

FIG. 22 is a flowchart illustrating a method of using golden signals for self-healing, under some embodiments.

FIG. 23 illustrates a telemetry system for merging dataset tables in time-series, under some embodiments.

FIGS. 24A, 24B, and 24C illustrate an example of a two tables merged to form a stored table, under an example embodiment.

FIG. 25 is a flowchart illustrating a method of creating and merging streaming telemetry data, under some embodiments.

FIG. 26 illustrates a telemetry system for encoding same data in streaming telemetry data, under some embodiments.

FIG. 27 is a flowchart that illustrates a process of encoding unchanged data in streaming telemetry data, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to a processing components for features implementing telemetry data process for cluster network filesystems (e.g., Santorini) for providing users with a flexible system environment where they can dynamically subscribe for different telemetry metrics through preferred transports.

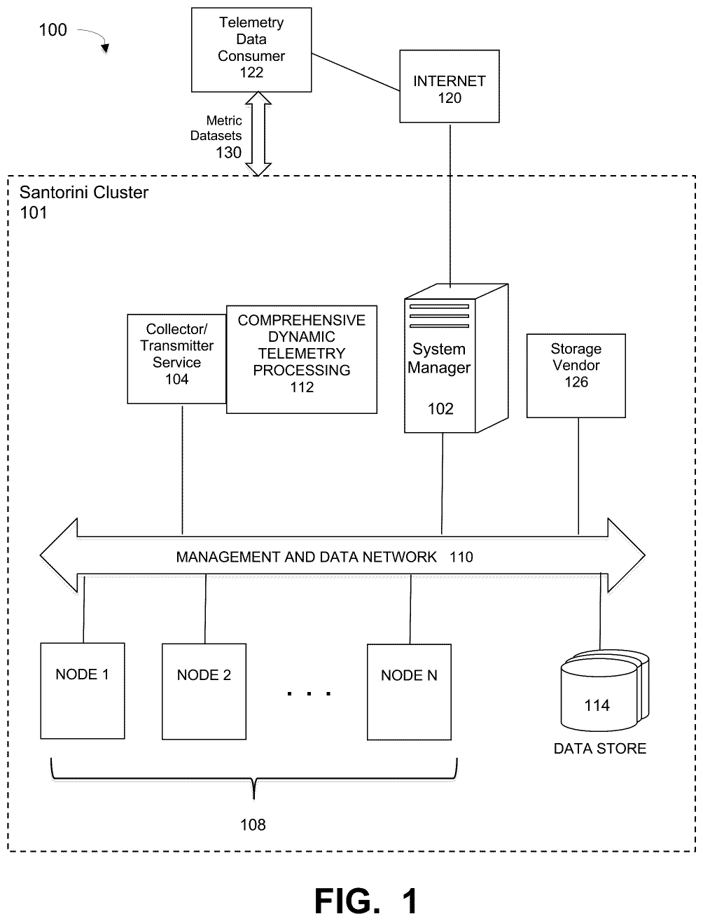

FIG. 1 is a block diagram illustrating a distributed system implementing flexible telemetry processing for cluster networks, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster or clustered system) typically consists of various components (and processes) that run in different computer systems (also called nodes) that are connected to each other. These components communicate with each other over the network via messages and based on the message content, they perform certain acts like reading data from the disk into memory, writing data stored in memory to the disk, perform some computation (CPU), sending another network message to the same or a different set of components and so on. These acts, also called component actions, when executed in time order (by the associated component) in a distributed system would constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case the Santorini network 101 supports various related filesystem and data managers, such as PPDM, as well as services such as ObjectScale and other services.

In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

As shown in FIG. 1, network 101 includes a collector service 104 and dynamic telemetry processing component 112 that is executed by the system to manage the telemetry architecture for users/customers of the system. Process 112 may be a process executed by a specialized node as a specially configured management or control node in system 100. Alternatively, it may be executed as a server process, such as by server 102 or any other server or client computer in the system. The telemetry management process 112 works with the other components of the distributed system and may use certain services or agents that run on each compute node 108 in the distributed system, such as may be implemented as a daemon process running in each node. As generally understood, a daemon is a computer program that runs as a background process, rather than being under the direct control of an interactive user.

As shown in FIG. 1, overall system 100 includes a storage system operated by a storage vendor 126 for protection of data of applications, operating systems, or resources of the cluster network 101. Such a vendor may be called upon to resolve issues or provide fixes to problems encountered by users of these products. In an embodiment, telemetry information 130 is transmitted between the vendor and telemetry data consumers 122, such as over the Internet 120 or over a local network link. In general, the telemetry can be sent to many destinations for use or “consumption” by many different types of consumers. One consumer might be a product customers or system users for their own management purposes. Another consumer might be internal processes that analyze telemetry and sometimes respond to adjust the system or send alerts to the vendor. The vendor itself may also be a consumer. Different types of telemetry can have different destinations, and some telemetry can go to multiple destinations.

Some consumers (e.g., vendors, system admins, etc.) may perform analysis, debugging, or modifications in the form of bug fixes, patches, revisions, etc., that the user can then install or execute in the cluster. In an embodiment, certain debugging tools may be provided in a node to help the vendor analyze and process the telemetry data. In general, the term “consumer” refers to any entity that receives the telemetry data for some use, and may include a user, subscriber, customer, receiver, and so on, of system data and resources. The telemetry data may be made available as part of any service, such as on a complementary basis or for a fee by a service provider by contract or subscription.

In an embodiment, system 100 includes a comprehensive dynamic telemetry management process that comprises several different sub-components to manage and implement various different aspects of producing, validating, consuming, and using the telemetry data in the system.

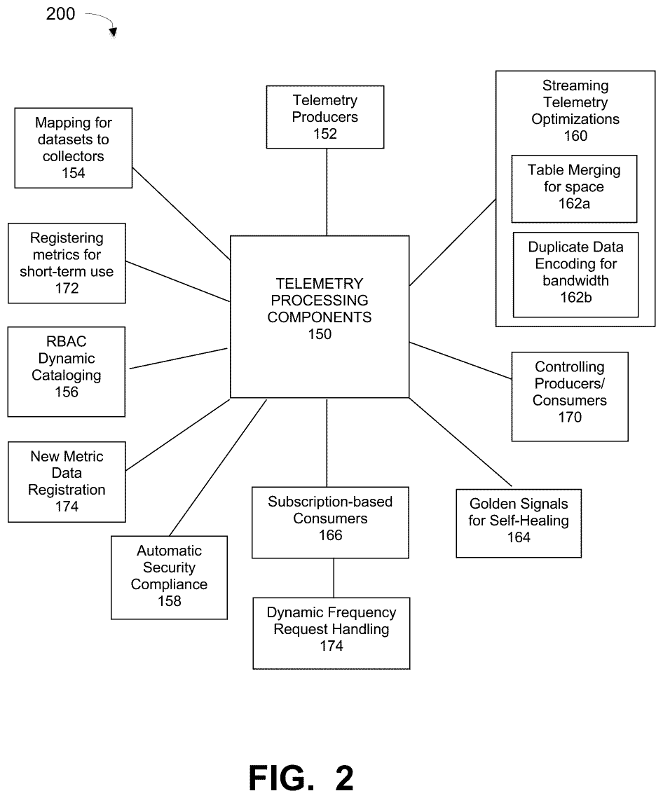

FIG. 2 is a diagram illustrating example telemetry service features for the system of FIG. 1. As shown in FIG. 2, the Santorini cluster 101 of FIG. 1 contains several different components 200 to provide telemetry services to the cluster as it performs its tasks of supporting applications in the system. The components of FIG. 2 allow services and producers to push telemetry to a centralized datastore. Telemetry collectors push consistent metrics to subscribed users or consumers (“subscribers”), which can be varied entities, such as graphical user interfaces (GUI), nodes (pods), or other processes internal or external to a product.

In system 200, telemetry producers 152 dynamically register to add new telemetry metrics. A subscription-based model is used to allow dynamic registrations from subscribers/users 166. The producers may be allowed access through role-based access control (RBAC) protocols. In an embodiment, system 200 may implement an open telemetry system (OTEL) that is opaque regarding transport of data to the subscribers.

The system allows dynamic frequency requests through a method to map data sets to collectors to optimize data collection and sharing, 154. It also provides RBAC-based dynamic cataloging and RBAC-based telemetry collection 156. Currently, catalogs do not show user based entries, and internal and external processes are not allowed to subscribe for different datasets. Process 156 remedies this shortcoming.

System 200 also includes automatic security compliance checks 158 for metric data during data collection, 158. Such compliance checks can be tunable with defined parameters and rules.

In enterprise-scale systems, a large number of both data producers and consumers may be generating and utilizing the data. System 100 includes processing components 170 to control certain aspects and operations of these producers and consumers.

System 200 further includes a component for processing golden signals that cover critical tasks related to data protection operations. These golden signals can be used to implement certain self-healing and debugging processes.

The telemetry data can be embodied as discrete datasets or as streaming (time-series) data. For streaming data, system 100 includes certain optimization features 160 including creating and merging tables for time-series to optimize data storage, 162a, and encoding duplicate data values to optimize network bandwidth, 162b. Other similar optimizations may also be provided.

The metric datasets may be of many different types for different uses, and a further optimization includes process 172 that registers metrics for short-term use to reduce resource use for these types of metrics.

Details of these functional components are provided in greater detail below. The functions illustrated in FIG. 2 are just some examples of possible functions, and embodiments are not so limited. Additional or different functions may also be used.

In an embodiment, cluster network 101 providing the features of system 200 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

In an embodiment, the dynamic telemetry process 112 is used in a clustered network that implements Kubernetes clusters. One such example network is the Santorini system or architecture, though other similar systems are also possible.

Such a system can be used to implement a Data Domain (deduplication backup) process that uses object storage (e.g., Dell ObjectScale), Kubernetes, and different types of storage media, such as HDD, Flash memory, SSD memory, and so on. In an embodiment, a PPDM (PowerProtect Data Manager) microservices layer builds on the Data Domain system to provide data protection capabilities for VM image backups and Kubernetes workloads. Santorini exposes a global namespace that is a union of all namespaces in all domains.

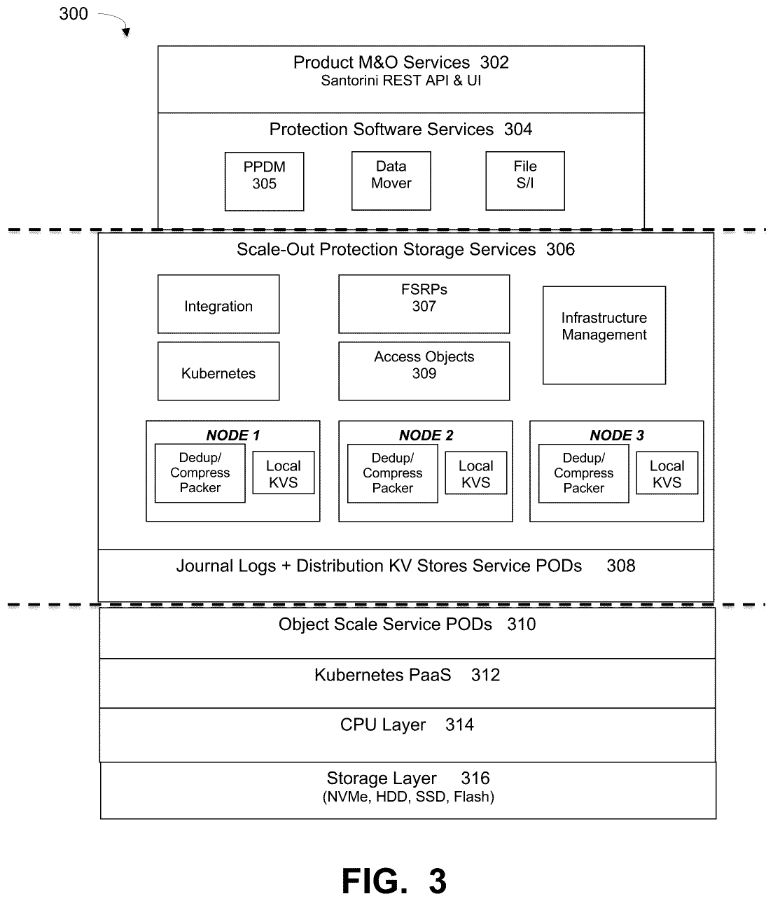

FIG. 3 illustrates an example of some services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks.

Also included in this layer 306 are any number of nodes (e.g., Nodes 1 to 3, as shown), each containing a dedup/compression packer and a key-value (KV) store.

Distributed key value (KV) stores are also a component of Santorini and are used to hold much of the metadata such as the namespace Btree, the Lp tree, fingerprint index, and container fingerprints. These run as containers within the Santorini cluster and are stored to low latency media such as NVMe. There is also a distributed and durable log that replaces NVRAM for Santorini.

### Subscription-Based Telemetry Architecture

Capturing data is critical to helping understand how applications and infrastructure perform at any given time. This information is gathered from remote, often inaccessible points within a system, and the data can be voluminous and difficult to store over long periods because of capacity limitations. As telemetry becomes more important for distributed software products, the need increases for flexible telemetry architecture defined for storage systems, as current systems are simply not dynamic enough to add new metric data sets, data producers or consumers in storage systems during runtime.

Telemetry data is typically made up of logs, metrics, and traces. Logs provide an event-based record of notable activities across the system and can be formatted as structured, unstructured, or plain text that give the results of any transaction involving an endpoint in the system, but that may require log analysis tools for user review. Metrics are numerical data points represented as counts or measures often calculated or aggregated over time. Metrics originate from several sources including infrastructure, hosts, and third-party sources. Most metrics are accessible through query tools. Traces are generated by following a process from start to finish (e.g., an API request or other system activity).

It should be noted that telemetry data may capture activities that comprise normal system operation or anomalies or fault conditions. Most telemetry data generated in a normal running system typically comprises routine system data. Telemetry data can also include or flag problems or issues in the system. Alerts are one type of telemetry indicating a problematic situation has occurred. In some cases, the system may be able to automatically recover from this condition. Other times, an alert means that support needs to be engaged to address the situation.

In an embodiment, the telemetry data of interest generally comprises metrics that may be provided in alphanumeric form and comprises information about a running system. Telemetry data is data that is generated periodically through normal system operation and that should be stored and transferred to users/clients when needed or requested. Such data may include characteristics such as space usage, latency for function calls or APIs, user-initiated operations, internal process status, network traffic, component temperatures, and so on. The telemetry data may be generated through generic system processes or Santorini-specific processes, such as backup/restore operations, deduplication processes, replication functions, configuration updates, Garbage Collection (GC) processes, and so on.

Telemetry data may be ultimately provided to an end user or administrator for system analysis, debugging, or other desired purposes. The telemetry data may be generated by the pods as raw data which is then transformed into formatted records for storage in a backend database. This data may then be input to a front-end database for use by the user. The telemetry data may be embodied as discrete datasets or as streaming (time-series) data.

In present systems, the telemetry data is based strictly on a static data definition. This results in fixed and non-flexible processing of such data. Embodiments provide a system that overcomes this shortcoming by providing a subscription-based approach to telemetry data generation and consumption, thus providing much greater flexibility in allowing new datasets, producers, and consumers to be dynamically defined and modified in running systems.

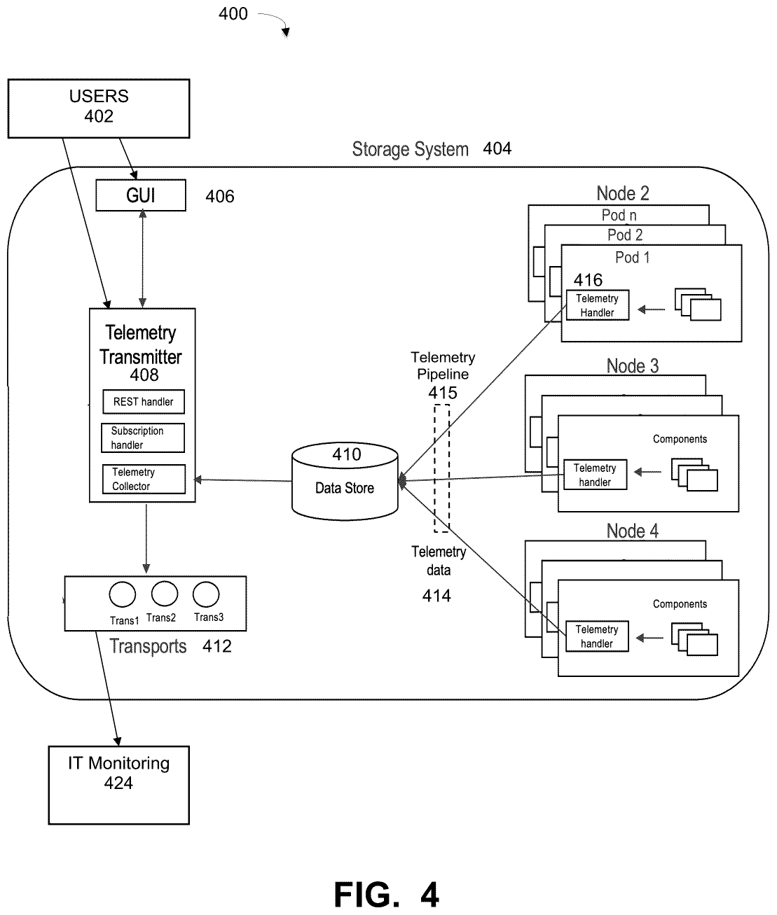

FIG. 4 illustrates an advanced telemetry architecture for Kubernetes-based storage systems, under some embodiments. As shown in FIG. 4, system 400 includes a containerized storage system 404 comprising a number of nodes (e.g., denoted Node 2, Node 3, Node 4, and so on), each having a number of pods (e.g., Pod 1 to n). Each pod has a telemetry handler component 416 that sends telemetry data 414 in the form of metrics to a datastore 410.

In system 400, telemetry consumers are allowed to make dynamic subscriptions for receiving different metric datasets 414 through one or more different transport mechanisms 412 (e.g., Webhook, SMTP, SNMP, etc.) for which they have subscribed. Consumers can be GUIs 406, internal pods, storage vendor IT backend systems 424, or storage system users. Raw data from the pods is collected through their respective telemetry handlers 416 and stored in a central datastore 410. In an embodiment, this can be done using Open Telemetry (OTEL) for a standard way of data collection. A telemetry transmitter 408 will then read data from datastore, perform any required processing and then send the telemetry data to the subscribers through the subscribed transports 412. FIG. 4 shows some example subscribers as an IT monitoring component 424 and GUI 406 for use by user 402, but other consumers are also possible.

For a containerized storage system 400, such as shown in FIG. 4, the telemetry processing system is pod-based rather than node-based to provide a high level of granularity with respect to telemetry data production and consumption.

As mentioned above, system 400 may utilize an OTEL framework, where OTEL is generally understood to be an open source observability platform comprising a collection of tools, APIs and SDKs. OTEL enables users to instrument, generate, collect, and export telemetry data for further analysis. OTEL can provide a standard format dictating how data is collected and sent through unified sets of vendor-agnostic libraries and APIs. It removes the need to operate and maintain multiple agents/collectors.

In an embodiment, system 400 may collect telemetry data by having each service send the data directly to a backend process. Alternatively, system 400 may utilize a collector process implemented alongside each service. This allows a service to offload data quickly. Such a collector can also take care of additional processing, such as retries, batching, encryption, filtering, and so on.

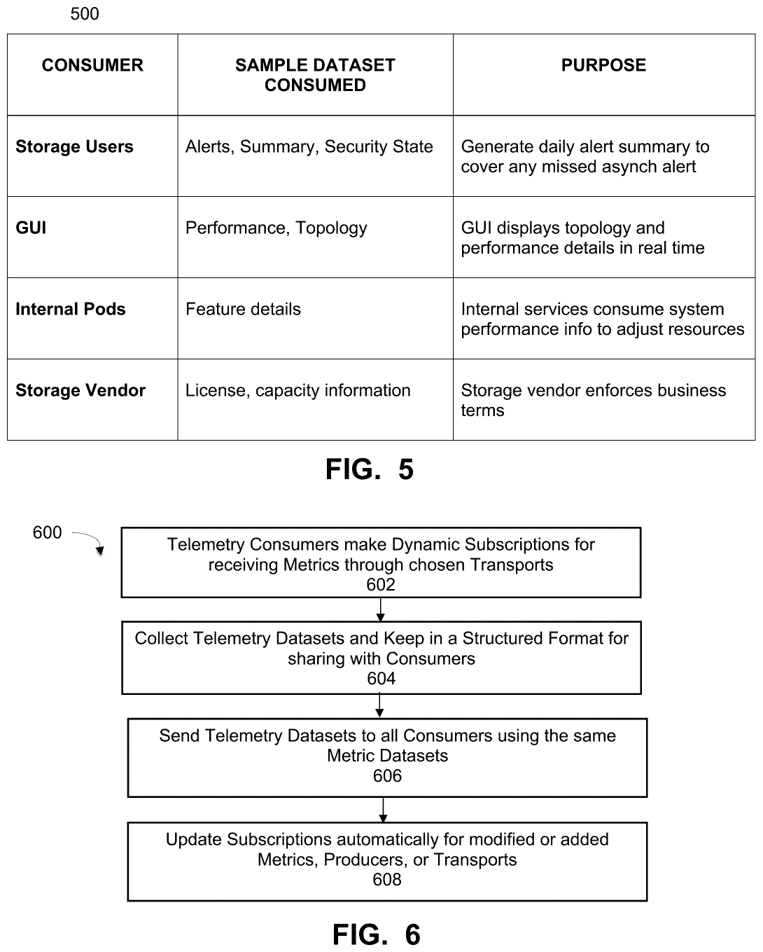

FIG. 5 is a table that lists some example consumers and datasets for the system of FIG. 4, under some embodiments. For purposes of the present description, the term “consumer” generally means an entity, process, or component that uses telemetry data, such as listed in table 500, a “subscriber” is a consumer that has subscribed to use of telemetry data through a transport mechanism 412, and a “user” is an entity, such as a person, who accesses the telemetry data through a consumer, such as a GUI 406 or other appropriate mechanism.

As shown in table 500, consumers may include storage users, GUIs, internal pods, and storage vendors, among other possible consumers. Various different telemetry data sets may be consumed by each consumer out of all of the telemetry data produced by the pods. For example, storage users may consume alerts, summary data, and security states of the pods for the purpose of generating periodic (e.g., daily or hourly) alert summaries to cover any asynchronous alerts that may have been generated but missed by any of the relevant components in the system. A GUI consumer may consume performance and topology telemetry data to display the relevant topology and performance details in real-time to any interested storage users. Internal pods may consume feature detail information to determined system performance for the purpose of adjusting resources (load balancing) and similar purposes. The storage vendor may consume license, capacity, and usage information to enforce system subscription and business/contract terms to make sure all users maintain fair usage of the storage system. FIG. 5 is provided primarily for purposes of illustration, and many other consumers, consumed data, and purposes are also possible.

In an embodiment, a catalog is used to store the list of schemas of available metrics to which consumers can subscribe. Every metric will be represented in the catalog using its schema. When new metrics get dynamically registered by any telemetry producer through a REST API, schema of these new metrics get updated to the catalog so that consumers get up-to-date catalog information for subscription.

As mentioned above, consumers are allowed to make dynamic subscriptions for receiving different metric datasets 414 through one or more different transport mechanisms for which they have subscribed. FIG. 6 is a flowchart that illustrates a process of implementing a subscription-based telemetry architecture for Kubernetes-based networks, under some embodiments. As shown in FIG. 6, process 600 begins by allowing telemetry consumers to make dynamic subscriptions for receiving metrics, 602. Subscribers can choose metric data sets and transports to receive those data sets. For example any consumer can customize notifications of data and the applicable datasets per system, as they can subscribe according to the system location or security setup, and so on.

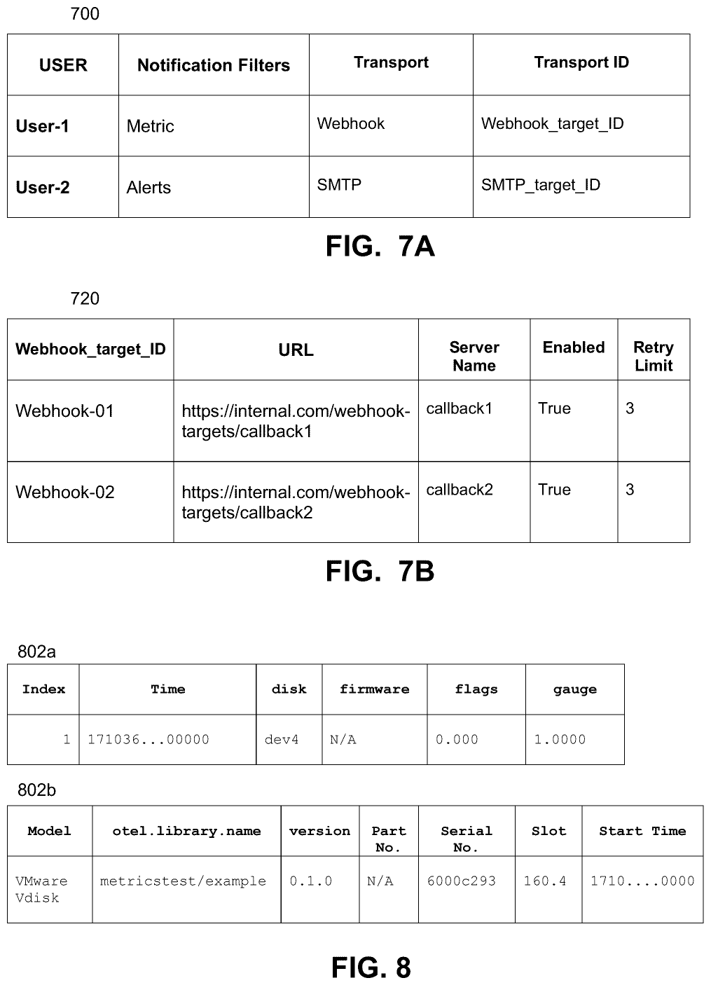

The subscription process utilizes a plurality of database tables to store subscription states and values formatted according to defined schema. Tables can be defined for storing consumer details, metrics that they subscribe to, and the transports to be used, and additional tables may be used for storing details of available transports. FIG. 7A illustrates an example user subscription table, under some embodiments. As shown for the example of FIG. 7A, two example users, “User-1” and “User-2” are listed. User-1 may subscribe to metric data through the Webhook transport, which has ID “Webhook_target_ID,” while User-2 may subscribe to alert data through the SMTP transport, which has ID “SMTP_target_ID. The entries of FIG. 7A are provided for purposes of example only, and any number of users and notification filters, transport mechanisms, and transport IDs may be used depending on system configuration.

A simplified subscription table may list metrics per user per transport as shown in example table 1 as follows:

TABLE 1

| | | |
|---|---|---|
| M1 | U1 | T1 |
| M2 | U2 | T2 |
| M2 | U3 | T1 |

In Table 1 above, Mx refers to a specific metric datasets out of all the available telemetry data, Uy references a particular user, and Tz references the selected transport mechanism. Thus, in the example of Table 1, metric M1 is sent to user 1 over transport 1, metric 2 is sent to user 2 over transport 2, and metric M2 is sent to user 3 over transport 1.

Each relevant entry in a consumer subscription table may generate different sub-tables. For example, table 720 of FIG. 7B illustrates a particular transport target table for FIG. 7A. As shown in FIG. 7B, the parameters associated with a particular transport, such as Webhook, may include a URL, server name, enable flag, and retry limit, among others. The entries of FIG. 7A are provided for purposes of example only, and any number of users and notification filters, transport mechanisms, and transport IDs may be used depending on system configuration. Any additional number of related or sub-tables for an initial user table, may also be provided.

For every type of transport, REST APIs are provided to consumers for subscription. For example, using the REST API for webhook subscription, a consumer can provide details of the webhook REST endpoint to be used for sharing metrics. The consumer can also mention which of the metrics from catalog need to be notified through the specified webhook REST endpoint. These details are stored in the consumer subscription table and other tables related to transports. Whenever scheduled telemetry jobs run and collect metrics, the consumer subscription table is checked. If there is a subscription for the collected metrics through a specific transport, the job will share the mentioned metrics through the specified transport.

Although embodiments are described with respect to using REST APIs, it should be noted that embodiments are not so limited. Other similar mechanisms that facilitate consumer access and subscription to the metrics are also possible. Likewise, the subscription table can be implemented through a system database or any similar centrally stored and accessible data element.

Telemetry datasets are collected and kept in a structured format for sharing with consumers, 604. The consumers can span various entities, such as GUI/pods across cluster nodes, storage system users, vendor IT backend, and so on. All such consumers get the same metric datasets from the central datastore to ensure data consistency, 606. At any point in time, therefore, the data received for a specific metric by all subscribers will be the same.

If any aspect of the network changes with respect to the production of telemetry data, the consumer subscriptions are all updated automatically, such as if any metric, producer, transport, and so on, is modified or added, 608. This update occurs within a defined period of time after the change occurs, and is implemented through an update to the relevant consumer databases. In an embodiment, when a producer registers a new metric using the registration REST API, this new metric is validated for schema and then added to the catalog dynamically. An info alert will be generated in the system so that prospective consumers are informed that a new metric is available for subscription. If any subscriber or system admin updates details of the transport enabled in the system, the transport details are automatically updated in respective database tables through a REST API workflow.

The raw data from a pod can be provided in any appropriate format depending on the type of pod/service and data type. For example, if a pod provides disk capacity data, such data can be formatted as follows:

```
master1:-/new_metricstest/data # cat data_domain_disk_capacity.json
  {
    “serial number”: “AUDVRN72S7DJCP”,
    “disk”: “dev4”,
    “slot”: “160:3”,
    “model”: “VMware Virtual_disk”,
    “firmware”: “n/a”,
    “type”: “SAS-SSD”,
    “partNumber”: “n/a”,
    “serialNo”: “6000c293a7d6......,”,
    “capacity”: 536870912000
  }
```

The above example shows programming code for an example virtual disk used in a Data Domain system. This data can converted to a structured format for storage in one or more tables in the datastore. FIG. 8 illustrates a table made up of parts 802a and 802b storing a dataset for a pod, under an example embodiment. It should be noted that the above shown programming code is provided for purposes of illustration only, and any data structure, programming language, definitions, values, and so on, may be used.

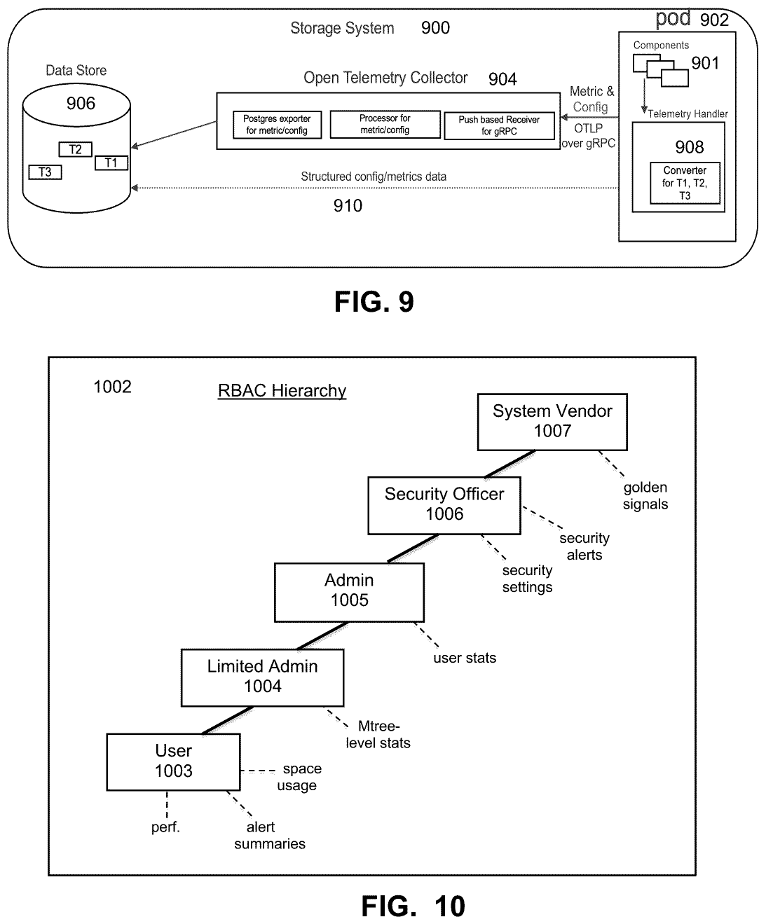

As shown in FIG. 4, the raw telemetry data 414 from the pods is sent through a pod resident telemetry handler 416 to the datastore 410. In an embodiment, the raw telemetry data 414 is sent to the datastore through a telemetry pipeline 415. FIG. 9 illustrates a telemetry data pipeline, under some embodiments. In FIG. 9, storage system 900 comprises a pod 902 coupled to datastore 906 through an open telemetry collector 904. The pod 902 contains certain components 901, such as disks, devices, and so on. These components all periodically generate telemetry data that is input to telemetry handler 908. The telemetry handler includes a converter to convert the telemetry datasets for the components, such as denoted T1, T2, T3, for the example of FIG. 9. The metric telemetry data is input from the pod 902 to the collector 904 over appropriate interfaces, such as OTLP (Open Telemetry protocol) gRPC (remote procedure call) interfaces, and the like. The collector includes a push-based receiver, a processor, and an exporter for the metric data. The datasets (T1, T2, T3) are then stored in datastore 906. In an embodiment, the metric data can also be converted to structured data in the pod's telemetry handler 908 and sent for storage in datastore 906 directly as the structured data 910.

Datasets are exposed to users through a variety of different interfaces (e.g., REST/CLI/GUI or notifications), and will be consistent at any time point as they are sent from the same data pool and pre-defined frequency.

Product vendors, through their backend components can subscribe for new datasets from systems in the field dynamically. Datasets shared with vendor backends are structured, and OTEL-based data enables community tools to be leveraged for data analytics.

In an embodiment, system 400 also provides dynamic frequency request handling for telemetry based on users, as shown in FIG. 2 with process 174 as part of the subscription service 166. For different consumers, the frequency of requiring metric datasets is typically different. For example, system admins may need an alerts summary from the system only once in a day if these administrators are already getting instantaneous alerts to their email addresses. A vendor, however, would need summary of alerts on the order of every several minutes so that it can do necessary analytics and proactive support actions without delay.

Current systems rely on telemetry collectors sharing metric data sets in pre-defined frequencies with all consumers. There is no choice for consumers to subscribe for a specific frequency for the dataset they need. To address this disadvantage, embodiments allow users to choose a metric along with the frequency by which subscribed metric will be transmitted to the user.

In an embodiment, the frequency of telemetry dataset transmission is based on a number of parameters, namely the user, the metric, and the selected frequency. These parameters dictate a highest data collection frequency (HDCF) value mapping to a particular metric. The HDCF can include a number of entries based on different combinations of metric datasets (M), selected frequencies (F), and users (U). There can be any number (X) of metric datasets depending on the number of pods and services, any number of frequencies (Y), and any number of users (Z). Various different HDCF values can be defined based on the various combinations of these factors.

The HDCF values for each metric are calculated and stored in the datastore. Pods generating raw data can tune their data collection frequency according to the HDCF. The telemetry collector can tune the collection of specific metrics from data store according to the subscription details and share with subscribers. Users can change the frequency for receiving metric data sets dynamically, and data generators can tune data generation frequency dynamically according to the value of HDCF. Data generation threads or collection jobs can be completely stopped if there is no subscribers for a particular dataset.

In an embodiment, the HDCF value is calculated per metric dataset when the ‘Get HDCF’ REST API is called by giving a specific metric dataset name (e.g., M1). The REST handler can parse the consumer subscription table to determine which is the highest frequency request among all subscriptions for the metric dataset.

### RBAC-Based Dynamic Catalog

In practically all commercial deployments of distributed data systems, certain data is sensitive enough to warrant protection by certain data security measures, such as storage in dedicated memory, enhanced backup and restore processes, access restrictions, heightened alerts, and so on.

A common way to protect such data is to limit access to users based on their identity and roles within the organization, such as by using role-based access control (RBAC) mechanisms. RBAC rules allow or allow or deny access to files or directories on the basis of role-permissions or user-role and role-role relationships, as opposed to strict user identities, such as used by access control list (ACL) control. Within an organization, roles are created for various job functions (e.g., Engineering, Sales, IT, Administration, etc.), and RBAC permissions assign certain operations or access permissions to specific roles. People can automatically acquire or lose permissions by taking on or losing different roles.

In an embodiment, the telemetry process 112 includes an RBAC-based dynamic catalog 115 to limit transmission of telemetry data to only those individuals having roles that are authorized to access the metric datasets. Through this process only subscribers that are allowed to subscribe for specific types of telemetry can receive that data. For example, metric datasets related to system security need not be sent to all consumers except security officer personnel, and so on.

In general, RBAC or other role-related access controls are typically based on a hierarchy of personnel in an organization in a top-down fashion, such as from a CEO to VP to department head to manager to employee, and so on. Those in a higher level of authority typically have access to all or most of the data, while those lower in the hierarchy are limited to accessing only certain types of data. The hierarchies may be defined within individual organizations or industries, and may encompass any practical number of data types, roles, personnel divisions, and so on.

For dissemination and access to telemetry data, as opposed to actual content data of the cluster network, the telemetry process 112 through the dynamic catalog 115 defines its own hierarchy with respect to security telemetry data access. FIG. 10 illustrates an example RBAC hierarchy used for the RBAC-based dynamic catalog, under some embodiments. As shown for the example of FIG. 10, the RBAC hierarchy comprises, from low to high, users 1003, limited administrators 1004, administrators 1004, security officer 1006, and system vendor 1007. In this hierarchy, the users are subject to most limited access and the system vendor is granted virtually unlimited access to the telemetry data, with increased levels of restriction for those roles/entities in between.

For the example of FIG. 10, users 1003 may be able to receive telemetry data relating only to performance, space usage, alert summaries, and so on. The limited administrators 1004 may be able to receive this information along with directory or Mtree-level statistics, while the administrator 1005 may be able to receive user statistics as well as the other lower level telemetry data.

With respect to security-related telemetry data, the security officer 1006 is generally the entity that is allowed to receive security setting, security alerts, and other similar telemetry data. In an embodiment in which the cluster network is provided for customer users as a platform solution, the system vendor is generally the only party entitled to access all of this telemetry data as well as so-called ‘Golden Signals’ that related to traffic, latency, errors, saturation, and other network related events and data, and that may be helpful to the vendor in identifying and addressing network issues.

It should be noted that FIG. 10 illustrates five distinct levels of role hierarchy with respect to telemetry data related to security aspects, however, embodiments are not so limited. Any practical number of levels comprising any appropriate division of roles and personnel may be used. Similar hierarchical roles can also be established and used for other aspects instead of or in addition to security data as well, such as performance related data, and so on.

The access to the appropriate data can be provided in any RBAC appropriate rule set either defined by the system itself, or as provided in any standard rule definitions that may be available for corporations, industries, and so on. For example, in a Kubernetes cluster network, the RBAC rules may be configured using built-in RBAC support APIs and a feature that creates objects provided by a function like: rbac.authorization.k8s.io.

In an embodiment, the RBAC-based aspect of metric dataset sharing is handled while accepting subscriptions from users. Every metric dataset will be shared with only eligible users or sets of users based on the RBAC hierarchy, such as shown in FIG. 10.

The metric datasets are cataloged through process 115 along with one or more RBAC rules. Every RBAC rule is mapped to set of user roles. For example, RBAC1 may be mapped to the user role 1003, RBAC2 may be mapped to the limited admin role 1004, and so on. Each metric dataset (e.g., Metric M1) will be stored in the catalog along with the applicable RBAC rule. The RBAC rules generally assign the access rights based on the hierarchy, such as shown in FIG. 10, where, for example, the security officer role 1006 includes privileges as a user 1003 plus more. When the metric catalog is requested by a user, the returned catalog will be filtered after checking that user's role and allowing transmission of only those metrics allowed for that role.

The RBAC catalog may be maintained in a database as a table, library, or any other appropriate data element accessible by process 115 of FIG. 1. The RBAC checks for the telemetry data access is done during metric data generation itself using the dynamic catalog, which itself can be updated as needed while the cluster network is running. In this manner, the catalog of metric telemetry data allowed for every user according to the role can be constantly updated and used, and a user can choose only metrics from the provided catalog for which they are entitled to access.

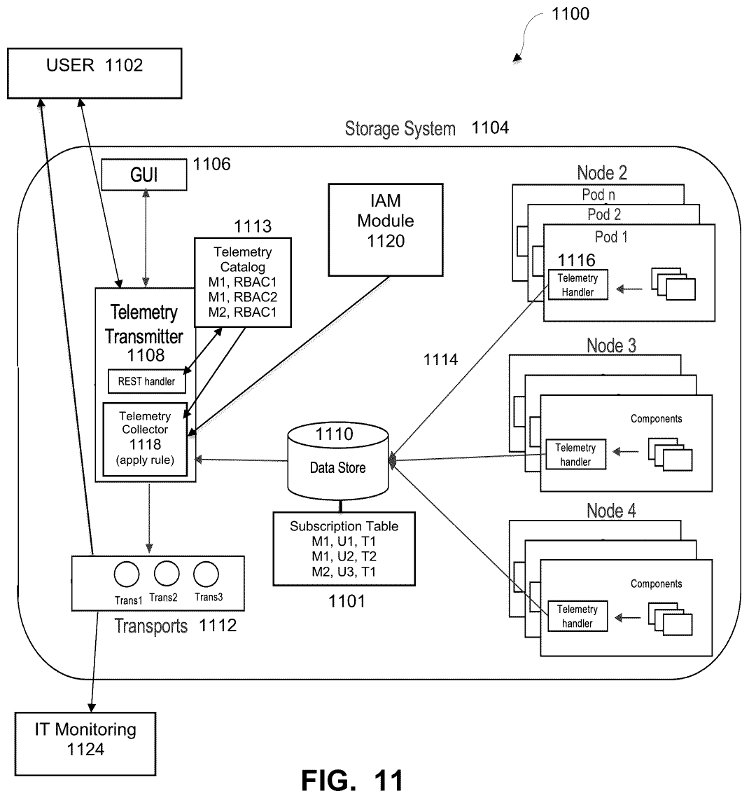

FIG. 11 illustrates a telemetry data processing system implementing an RBAC-based dynamic catalog, under some embodiments. automatic checkpoints can be added using the compliance-check library. System 1100 of FIG. 11 includes a containerized storage system 1104 comprising a number of nodes (e.g., denoted Node 2, Node 3, Node 4, and so on), each having a number of pods (e.g., Pod 1 to n). Each pod has a telemetry handler component 1116 that sends telemetry data 1114 in the form of metric datasets to a datastore 1110. Telemetry consumers (users) make dynamic subscriptions (as described above) to receive metric datasets through one or more different transport mechanisms 1112. Raw data 1114 from the pods is collected through their respective telemetry handlers 1116 and stored in the central datastore 1110. A telemetry transmitter 1108 reads data from datastore, performs any required processing and then sends the telemetry data to the users 1102 or other entities, such as IT monitoring 1124 through the subscribed transports 1112.

As described above, the various consumers of telemetry data 1114 subscribe to receive desired metric datasets over appropriate transports 1112. A subscription table 1101 (such as illustrated in Table 1, above) can be set up and stored in the datastore 1110.

In system 1100, besides the subscription terms, access to the telemetry data is further checked against RBAC restrictions. FIG. 11 shows the incorporation of an RBAC-based dynamic catalog, under some embodiments. For the embodiment of system 1100, storage system 1104 has or has access to an IAM (identity and access) module. This may be implemented through an on-board IAM server or service provider (internal or external). The IAM module provides the framework for business processes and policies that facilitates the management of digital identities of the entities of system 1104, and that are used by the processes and administrators to control user access to data in the system. In an embodiment, the IAM module 1120 interfaces with the telemetry collector 1118 of telemetry transmitter 1108 to control access to the telemetry data 1114.

A dynamic telemetry catalog 1113 stored in or accessible by the telemetry transmitter 1108, such as through a REST handler) stores metric dataset to RBAC rules. The dynamic telemetry catalog associates metric datasets (denoted Mx) by type against different RBAC rules (denoted RBACy). The RBAC rules are each mapped to a specific role in the hierarchy. Thus, for the example of FIG. 10, there would be five RBAC rules denoted RBAC1 to RBAC5, with possibly RBAC1 mapped to users, RBAC2 mapped to limited admins, all the way to RBAC5 mapped to the system vendor.

The telemetry catalog 1113 comprises a database or table that associates the metric datasets with any and all of the RBAC rules that apply. A simplified telemetry catalog may list metrics per user per transport as shown in example table 2 as follows:

TABLE 2

| | |
|---|---|
| M1 | RBAC1 |
| M1 | RBAC2 |
| M2 | RBAC1 |

In Table 1 above, Mx refers to a specific metric datasets out of all the available telemetry data, and RBACy references a RBAC rule. Thus, in the example of Table 1, metric M1 is sent to users satisfying rule RBAC1 and users satisfying rule RBAC2, metric 2 is sent to users satisfying rule RBAC1.

In an embodiment, the IAM module 1120 provides the user and RBAC mapping that is stored in the catalog and used by the telemetry collector 1118. The telemetry collector applies a hierarchical relationship rule to determine whether or not a user can be sent the metric dataset. In a hierarchical scheme, such as in FIG. 10, any user with a RBAC level equal to or greater than (>=) the RBAC rule level can receive the metric dataset. Thus, the rule may be enunciated as: “if user's RBAC>=catalog RBAC, then send”. This illustrates one possible and common rule, however other rules are also possible, strictly greater than (>), and so on. Likewise, if a non-hierarchical organization is used, the rule may require explicit correspondence of metric dataset to each RBAC level, in which case, the rule may be strictly equal to (=).

In an embodiment, the catalog 1113 can be provided to the user 1102 so that all users in a system are made aware of the RBAC restrictions on dissemination of telemetry data.

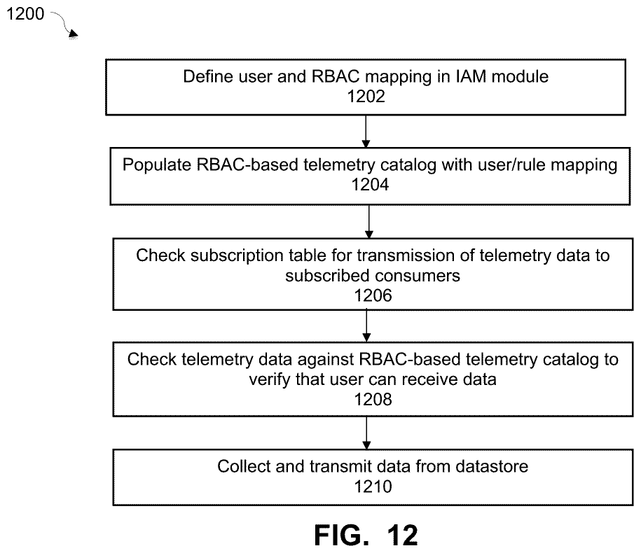

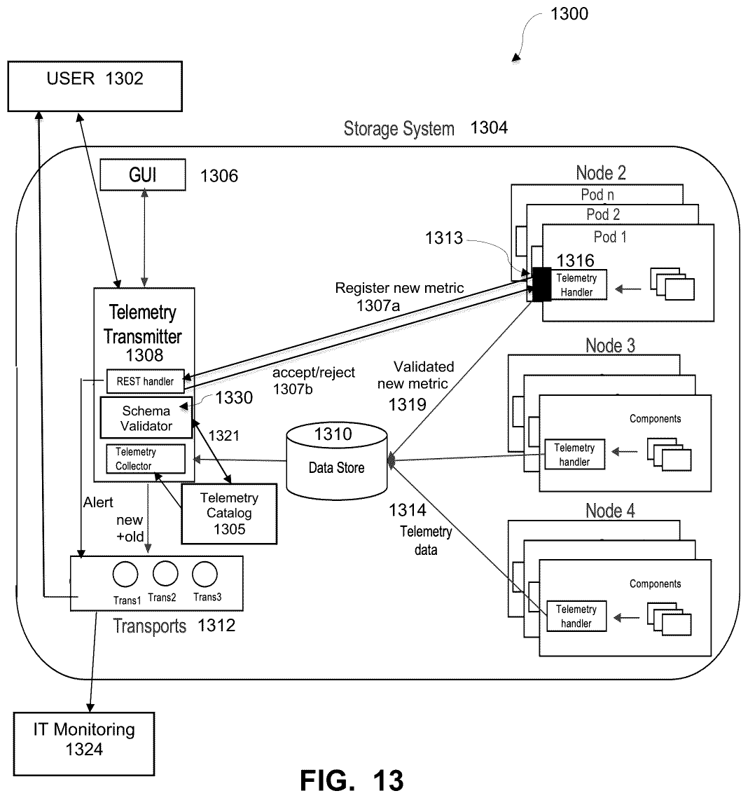

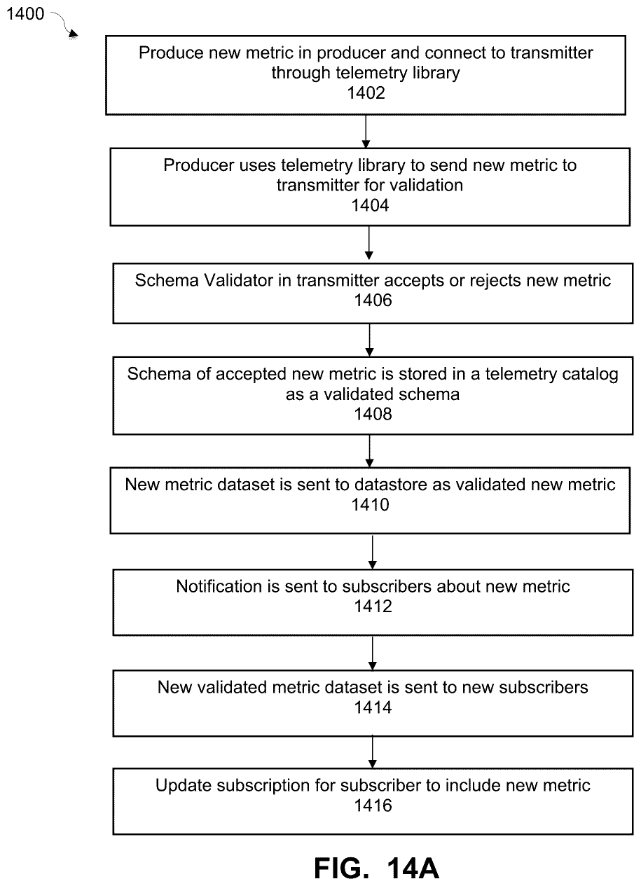

FIG. 12 is a flowchart that illustrates a method of allowing access to telemetry data through an RBAC-based dynamic catalog, under some embodiments. Process 1200 of FIG. 12 begins with step 1202 of defining the user and RBAC mapping in the IAM module or similar management process. This mapping defines a correlation of metric datasets to corresponding RBAC rules, which are stored in an RBAC-based catalog accessible by the telemetry collector of the telemetry transmitter, 1204.

As telemetry data is generated and stored in a datastore, it is sent to a telemetry transmitter for transmission to subscribed consumers per their respective subscriptions. For this process, a subscription table is checked to verify only valid subscribed consumers will receive the data per their selected transport, 1206.

The metric datasets of the telemetry data are checked against the RBAC-based telemetry catalog to verify that the user can receive the telemetry data per the applicable RBAC rule, 1208, and if so, the data is collected and transmitted by the telemetry transmitter, 1210.

This process adds a second layer above subscription information to safeguard the security of telemetry data based on RBAC rules, and allows the system to define conditions under which certain users can receive certain types of telemetry data in an efficient and dynamic manner.

Embodiments have been described with respect to RBAC rules for access restriction, however, other similar mechanisms may also be used. For example, an Access Control List (ACL) is a list of permissions associated with data objects that specifies which users or system processes are allowed on given objects. It is usually embodied as a table specifying a subject and an operation, such as (Jane: read, write; John: read). Instead of RBAC rules, an ACL or similar filter process may also be used.

### Dynamic Registration and RBAC Allocation of New Metrics

As stated above, current telemetry systems in cluster networks lack flexibility to easily add new metric datasets, data producers, or consumers to the system. For example, in present systems, if components need to add any new dataset or metric to the telemetry workflow, they must follow manual steps for integrating the new data with the telemetry pipeline, telemetry collectors and telemetry processors. Adding a new feature, such as data movement to cloud in which the telemetry dataset will be new is a manual operation. In existing telemetry infrastructures, there is no provision to automatically register new metrics to the existing telemetry data.

Embodiments of the dynamic telemetry process 112 include a dynamic registration process for new metrics that may be implemented by component 174 of FIG. 2. This process includes a registration method for data producers to add new data sets dynamically to the telemetry workflow. This involves making dynamic changes to the data handling procedures at multiple points, including data generation, data collection, data storing, data sharing with subscribers, and so on.

In an embodiment, the telemetry producers are provided with a telemetry library that connects with a REST API in the telemetry transmitter to register new metrics. A registration API allows the producer to share a schema for the new data, which the registration API will then verify to determine whether or not the schema is approved to add a new dataset. Once the new metric is validated, it will be added to the telemetry catalog. At the same time, the REST handler will send an information alert to all the subscribers notifying them that a new metric dataset is available for subscription. Users can then access the catalog to discover the new metric schema and subscribe if needed.

When the data streams are first created for the newly registered dataset, a telemetry library can validate the generated data set against the registered schema in the catalog and then store it in the datastore. The OTEL-based telemetry pipeline already has the capability to add new OTEL streams dynamically for the new dataset and time-series tables will be created for the new metric. The telemetry collector checks subscriptions and if any subscription for the new metric is found, it will collect and send new metric dataset along with the current metrics to subscribers.

FIG. 13 illustrates a telemetry data processing system implementing dynamic registration of new metrics, under some embodiments. System 1300 of FIG. 13 includes a containerized storage system 1304 comprising a number of nodes (e.g., denoted Node 2, Node 3, Node 4, and so on), each having a number of pods (e.g., Pod 1 to n). Each pod has a telemetry handler component 1316 that sends telemetry data 1314 in the form of metric datasets to a datastore 1310. Telemetry consumers (users) make dynamic subscriptions (as described above) to receive metric datasets through one or more different transport mechanisms 1312. Raw data 1314 from the pods is collected through their respective telemetry handlers 1316 and stored in the central datastore 1310. A telemetry transmitter 1308 reads data from datastore, performs any required processing and then sends the telemetry data to the users 1302 or other entities, such as IT monitoring 1324 through the subscribed transports 1312.

As described above, the various consumers of telemetry data 1114 subscribe to receive desired metric datasets over appropriate transports 1112. A subscription table (such as illustrated in Table 1, above) can be set up and stored in the datastore 1310.

In system 1300, one or more of the telemetry producers (e.g., pods and nodes) can add new telemetry metrics to be sent to the consumers (e.g., users, monitors). As shown for the example of FIG. 13, Pod 1 of Node 2 adds new metrics through a telemetry library 1313. This telemetry library allows the producer to share the schema of the new data so that it can be approved for use. Using appropriate APIs between the producer and telemetry transmitter, this new metric is registered 1307a through the REST handler of the telemetry transmitter 1308. A schema validator 1330 in the transmitter 1308 accepts or rejects the new metric 1307b. The schema validator checks the form of the new metric to make sure it conforms to defined schema for the metric datasets. When a new metric is validated by the schema validator, the schema stored through step 1321 in the telemetry catalog 1305. At this point, the new dataset from the telemetry producer library 1313 is sent by the telemetry handler 1316 is the producer to the datastore 1310 as a validated new metric 1319.

After acceptance of the new metric, the telemetry transmitter 1308, through the REST handler sends a notification alert to the subscribing users through the transports 1312 to notify them that a new metric dataset is available. If any subscriber elects to subscribe to the new metric, the transports 1312 will receive the current (old) datasets along with the new dataset 1319 from the datastore and telemetry transmitter for dissemination to the appropriate subscriber or subscribers.

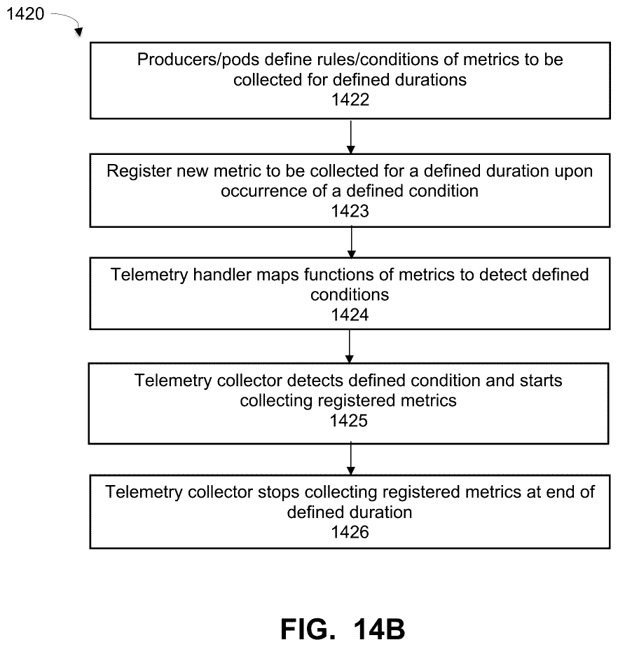

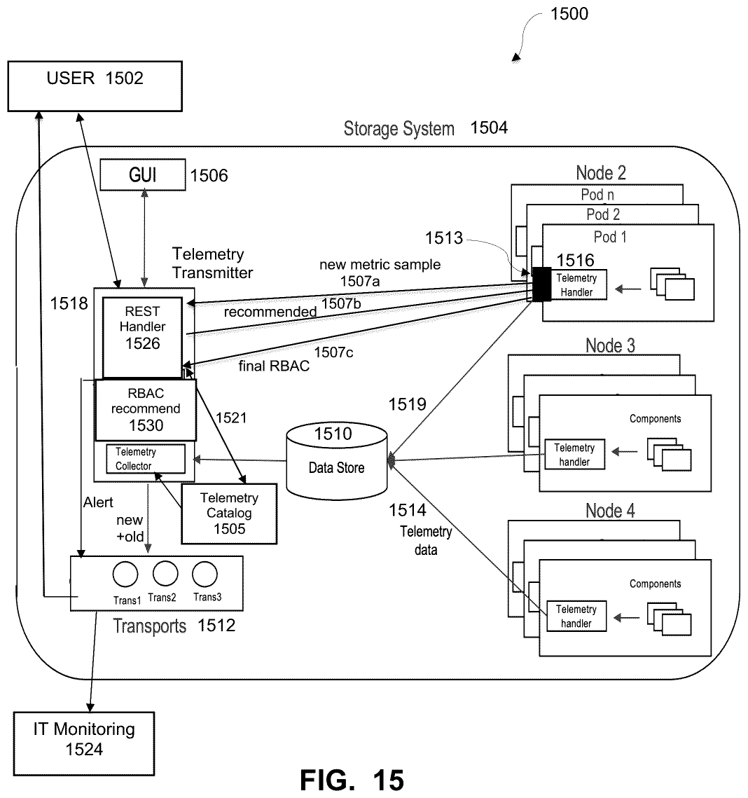

FIG. 14A is a flowchart that illustrates a method of dynamically registering new telemetry datasets, under some embodiments. Process 1400 of FIG. 14A begins with step 1402 of generating a new telemetry dataset in a telemetry producer. A telemetry is provided to the producer to connect through the REST API in the telemetry transmitter to register the new dataset, 1404. A schema validator in the telemetry transmitter checks the schema of the new metric and accept or rejects the new metric, 1406. If accepted, the schema of the new metric is stored in a telemetry catalog as a validated schema, 1408. The new metric dataset is then sent to the datastore from the producer as a validated new metric, 1410. The schema validator may have defined rules that check the schema against the defined format requirements, such as valid JSON format, nesting within a number (n) of fields not beyond a maximum, and so on.

Subscribers are notified as to the addition of the new schema, 1412, and any subscriber that elects to receive new metric datasets can then receive them through the telemetry transmitter, 1414. Any subscriber receiving the new metric will have their subscription terms updated to include the new metric, 1416.

The process 1400 is dynamic in that the new telemetry data can be generated and validated with the telemetry catalog updated as needed while the cluster network is running. In this manner, the catalog of metric telemetry data allowed for every newly generated metric can be constantly updated and used. Furthermore, subscribers are alerted in real-time as to the new metric and their subscriptions can be immediately updated to include these new metrics.

In general, the metric datasets can encompass a wide variety of data. Many metrics, such as logs, are relatively long-lived. Other metrics, however, such as traces may need to be run only for short durations. Present systems do not adequately accommodate such short-term metrics for efficient telemetry data processing.

In an embodiment, system 200 includes a component 172 for registering for short duration metrics as part of the dynamic telemetry process 112, and may be used for existing metrics or when new metrics are registered. This process enhances the telemetry infrastructure 100 to support short duration metrics, and other metrics that may need to be enabled and disabled depending on certain conditions.

During registration of any new metric, pods can define rules and conditions when certain defined metrics need to be collected and the duration. Such defined metrics are registered for a short duration, where the duration may be on the order of minutes, hours, or days, depending on system configuration and requirements. For example, a DDFS pod can specify a condition such as ‘ddfs_core’ with a duration of one day. Likewise, a security pod can add condition like ‘hacker_detection’ with a duration of one day, while a health monitor pod can add condition like ‘I/O_slowness’ with a duration of 3 days. All of these conditions will be implemented in a telemetry handler with mapping functions that can detect the condition in the system by checking alerts or logs, or other methods.

Upon detecting a specified condition, the telemetry collector will start collecting registered metrics for the specified duration and then stop collection. This process allows the system to dynamically collect specific metrics for specified duration on pre-defined conditions using new metric data registration method.

FIG. 14B is a flowchart that illustrates a method of dynamically registering metrics for short duration, under some embodiments. Process 1420 of FIG. 14B begins with producers defining rules and conditions of a metric to be collected for a defined duration, 1422. Such a duration is bounded and typically short, such as on the order of less than one week or one month, and the defined metric typically comprises metric data that captures instantaneous events, such as traces, as opposed to regular periodic events, such as logs. A producer can register a new metric to be collected for a defined duration upon occurrence of a defined condition, 1423.

The telemetry handler maps functions of the metric to detect defined conditions to start collection of the metric, 1424. Upon detection of the condition, the telemetry collector starts collecting the metric, 1425. The condition essentially triggers collection of the metric, and the defined duration dictates how long the metric will be collected once triggered. At the end of the defined duration, the telemetry collector stops collecting the metric, 1426. This process allows collection and transmission of the metric to be enabled and disabled based upon defined conditions.

Embodiments further include a mechanism to provide for dynamic access control permissions or allocations for newly added metrics. This allows RBAC rules to be dynamically added or modified to accommodate new metrics in a running system.

In an embodiment, system 200 of FIG. 2 includes an RBAC-based dynamic catalog 156 and new metric dynamic registration process 174 that work with the dynamic telemetry process 112, as described above. The two processes 115 and 117 work together to process the RBAC rules for new metrics so that they can be accessed only by those users who are eligible based on their identity and roles as defined by an identity access management module.

In an embodiment, an RBAC recommendation module in the telemetry collector of the telemetry transmitter. When producers (e.g., pods) register a new metric through the telemetry collector's REST API, the RBAC recommendation module can be used to parse a sample data set and recommend which RBAC category the new metric should be aligned with from the provided RBAC hierarchy. Every RBAC level in the hierarchy (e.g., hierarchy 1002 of FIG. 10) can be associated with a set of key-value (KV) patterns, which can be used by the RBAC recommendation module while parsing sample data. For example, a KV pair like “IP_address=1.2.3.4” can be parsed and that metric can then be categorized for a certain level, such as user level 1003 within hierarchy 1002, while a different KV pair like “email=xx@y.com” can be parsed and that metric can be categorized for a different level, such as security officer level 1006 within the hierarchy 1002.

Once the producer that is registering the new metric receives the recommendation, it can tune the RBAC rule to a final RBAC rule and confirm back to the telemetry collector. The telemetry collector will then verify whether the final RBAC level is greater than or equal to (>=) the hierarchy level in the recommended RBAC level. If it is not, it will reject the final one and registration of new metric data set will be incomplete. Once the telemetry collector ensures the final RBAC is proper, it will enter both the new metric data set and its RBAC into the telemetry catalog. This allows producers to tune the RBAC rules to make them more restrictive, but they are not allowed to change the RBAC level to any lower hierarchy level.

FIG. 15 illustrates a telemetry a data processing system dynamically allocating RBAC rules for new metric data sets, under some embodiments. System 1500 of FIG. 15 includes a containerized storage system 1504 comprising a number of nodes (e.g., denoted Node 2, Node 3, Node 4, and so on), each having a number of pods (e.g., Pod 1 to n). Each pod has a telemetry handler component 1516 that sends telemetry data 1514 in the form of metric datasets to a datastore 1510. Telemetry consumers (users) make dynamic subscriptions (as described above) to receive metric datasets through one or more different transport mechanisms 1512. Raw data 1514 from the pods is collected through their respective telemetry handlers 1516 and stored in the central datastore 1510. A telemetry transmitter 1508 reads data from datastore, performs any required processing and then sends the telemetry data to the users 1502 or other entities, such as IT monitoring 1524 through the subscribed transports 1512.

As described above, one or more of the telemetry producers (e.g., pods and nodes) can add new telemetry metrics to be sent to the consumers (e.g., users, monitors). After the new schema is approved, it is stored in the telemetry catalog 1505 and the new metric dataset 1519 is stored in the datastore 1510. In system 1500, this new metric dataset is processed using a telemetry library 1513 of the telemetry handler 1516 of the producer (e.g., Pod 1 of Node 2). The RBAC-based dynamic catalog process 115 is then used to allocate the RBAC rules for these new metric datasets.

In system 1500, the producer registers the new metric through the REST handler 1526 of the telemetry transmitter 1518. As part of the RBAC allocation process, the producer sends a sample of the new metric 1507a to the REST handler. An RBAC recommendation module 1530 in or associated with the telemetry collector parses this sample and recommends an RBAC level that the new metric should be aligned within the defined RBAC hierarchy, and returns this recommendation 1507b back to the telemetry handler 1516 of the producer. The producer then tunes the RBAC level to generate a final RBAC level 1507c for the new metric, and sends it back to the REST handler 1526. This new RBAC value is then verified by the telemetry collector and the new metric and its RBAC level is loaded into the telemetry catalog 1505.

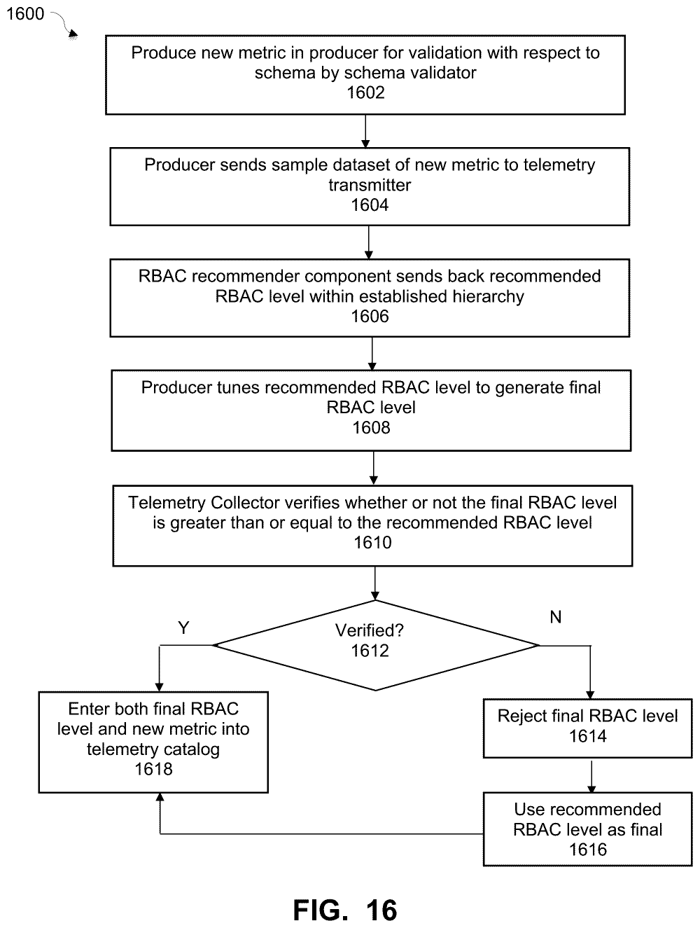

FIG. 16 is a flowchart illustrating a process of dynamically allocating RBAC rules for new metric data sets, under some embodiments. Process 1600 of FIG. 16 begins with step 1602 of generating a new telemetry dataset in a telemetry producer for validation of the metric schema by a schema validator, as described with respect to FIG. 14A. Once validated, the RBAC rules for this new metric can be established to control access per the access rules set within the system.

The producer sends a sample dataset of the new metric to the telemetry transmitter, 1604. The RBAC recommender component 1530 within the telemetry transmitter then sends back a recommended RBAC level based on the established hierarchy, 1606. The producer receives the recommended RBAC level and tunes it to generate a final RBAC level, 1608. The final RBAC level is then checked by the telemetry collector to verify that the final RBAC level is greater than or equal to the recommended RBAC level, as the producer is not allowed to set the RBAC level for the new metric lower than the recommendation, 1610. If, in step 1612, it is determined that the final level is not verified to be greater than or equal, then the final RBAC level is rejected, 1614. In this case, process may stop, or the recommended value is used for the new metric as the final RBAC level, 1616. If the final value is verified, or if the recommended level becomes the final level, the final RBAC level and new metric are loaded into the telemetry catalog, 1618.

### Security Compliance Check

Many types of data can be deemed to be restrictive, confidential, sensitive, protected and so on, under one or more compliance guidelines, such as privacy regulations under GDPR. The telemetry generated during processing of such data similarly needs to align to these regulations. Any data that is generated from a provider without any security compliance checks must be checked at every intermediate point in the telemetry architecture to verify that it is in compliance with security guidelines. This imposes a great deal of potential processing overhead, as well as data storage checks to ensure that such data is encrypted and not exposed in plaintext to any user.

In an embodiment, process 112 includes an automatic security compliance check process to verify that every telemetry data generating process should ensure that the data is GDPR compliant, and that only compliant data is sent to the telemetry workflows. This is illustrated in the system of FIG. 2, with component 158. In a large system, automation is required to ensure that the data generated is always compliant, regardless of producer, consumer, or system administrator involvement.

In an embodiment, all telemetry data that is generated for transmission to a consumer is automatically processed through a compliance-check library depending upon its data type. A datatype check is performed to route data to an appropriate compliance-check library, or filter data out from further compliance checks, if necessary, for efficient processing.

For GDPR environments, this library comprises the GDPR checklist that includes currently established main items of compliance under present GDPR regulations, such as: (1) lawful basis and transparency of data usage, which verifies how and who processes the data and the legal justification for the processing; (2) data security, which validates security policies and features of the data process, as well as the alert or notification measures; (3) accountability and governance which specifies who is responsible for ensuring GDPR compliance and the role of a data protection officer; and (4) privacy rights, which covers the disclosure of personal data use and opt-out provisions.

The GDPR checklist may be maintained in a database as a table, library, or any other appropriate data element accessible by process 112 of FIG. 1. It should be noted that although embodiments are described with respect to compliance checks with respect to GDPR regulations, embodiments are not so limited. Any data processing environment that imposes defined restrictions on the use, transmission, storage, access, and so on, of any data can also be included.

The automatic security compliance check processing component 158 goes through the checklist and ensures that data is obfuscated as specified in the checklist. Consumers of the data can get or modify this checklist dynamically after proper authentication. Producers will receive an error message in case any dataset fails compliance check or data obfuscation according to the compliance checklist. Any dataset that fails the compliance check cannot be sent to the datastore by the producer. It is up to the producer to then take appropriate actions, like collect data that is compliant or notify the consumer through an alert that it is not able to share non-compliant data with the datastore.

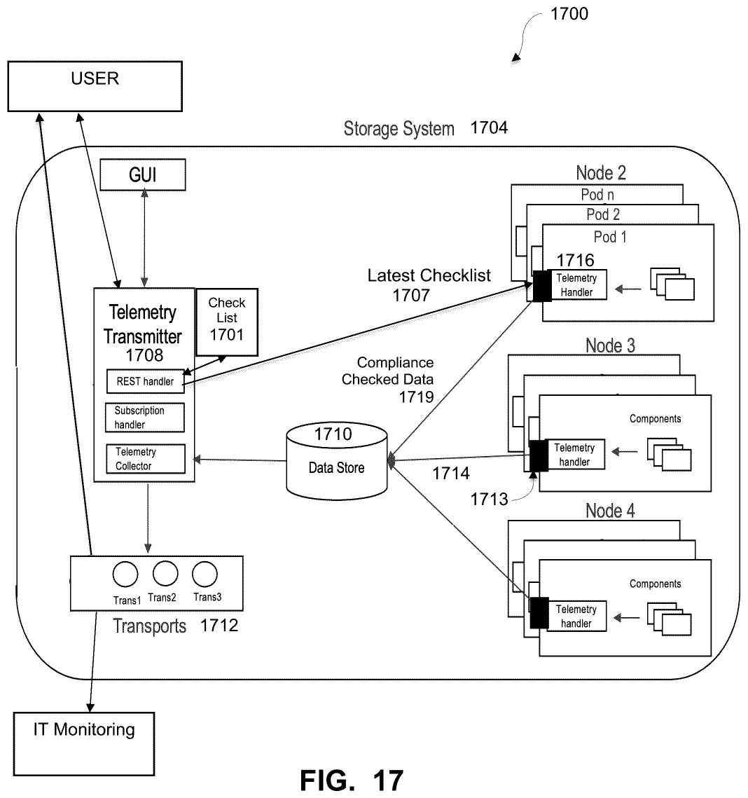

FIG. 17 illustrates a telemetry data processing system implementing automatic security compliance checks, under some embodiments. Automatic checkpoints can be added using the compliance-check library. As described above with respect to embodiments system 1700 includes a containerized storage system 1704 comprising a number of nodes, each having a number of pods (e.g., Pod 1 to n). Each pod has a telemetry handler component 1716 that sends telemetry data 1714 in the form of metric datasets to a datastore 1710. Telemetry consumers (users) make dynamic subscriptions (as described above) to receive metric datasets through one or more different transport mechanisms 1712. Raw data 1714 from the pods is collected through their respective telemetry handlers 1716 and stored in the datastore. A telemetry transmitter 1708 reads data from data store, performs any required processing and then sends the telemetry data to the users through the subscribed transports 1712.

FIG. 17 shows the incorporation of a security compliance check process utilizing a checklist 1701 and compliance check library 1713 components, under some embodiments. As shown in system 1700, a compliance checklist in or accessible to the telemetry transmitter 1708 is accessed by the user 1702 through the REST handler. The user can read and update the compliance checklist as needed. A current or updated checklist is distributed as the latest checklist 1707 to the compliance check library 1713 maintained by the telemetry handler 1716 of each pod in each node. When telemetry data is sent from the telemetry handler, the respective checklist library 1713 is checked to produce compliance checked data 1719. This compliant data is then stored in datastore 1710 for processing by the telemetry collector of the telemetry transmitter 1708.

In this manner, the security compliance check and needed processing for the telemetry data is done during metric data generation itself using the combination of a dynamic checklist 1701 and a library 1713 generated from the checklist. Consumers or generators of the metric data can collect the dynamic checklist from the system so that they can tune compliance check of their metric datasets.

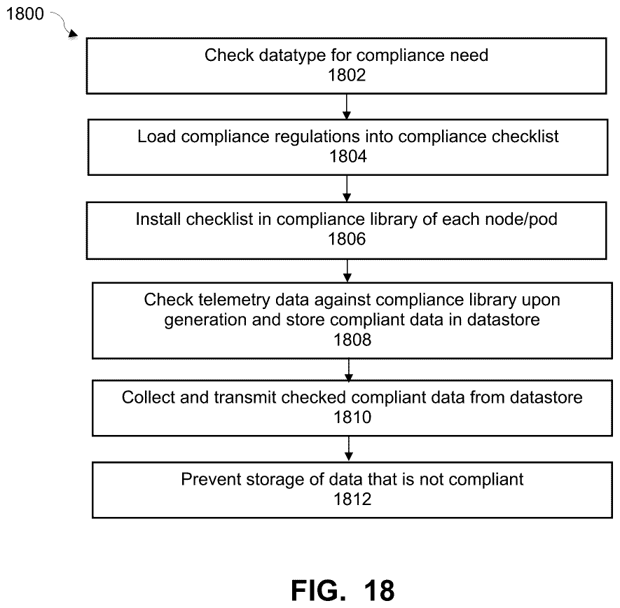

FIG. 18 is a flowchart that illustrates a method of implementing automatic security compliance checks, under some embodiments. Process 1800 of FIG. 18 begins with in step 1802 of automatically checking the telemetry data as it is generated with respect to datatype to determine whether the data is or is related to data that is subject to security compliance regulations. Such a determination can be made based on tags associated with the data (e.g., confidential, privileged, secret tags, etc.), intelligent processes that automatically recognize data subject to regulation (e.g., PII, system IP, etc.), or other similar processes.

The compliance regulations are provided in a compliance checklist maintained by the telemetry transmitter, 1804, and provided to a compliance library maintained by the telemetry handler of each telemetry producer (pod), 1806. A user or system administrator can occasionally and regularly review and update the compliance checklist as needed, and this updated information is immediately transmitted to update the compliance libraries in the producers. The checklist and libraries can be dynamically updated as the system is running so that up-to-date compliance information is always used to check the telemetry data. Initial and updated compliance regulations can be provided to the user through appropriate regulatory authorities or service providers.

When telemetry data of the appropriate type is generated by the producer, it is automatically checked against the compliance library in the producer pod and then stored as compliance checked telemetry data in the data store, 1808. The telemetry transmitter can then collect and distribute the compliance checked telemetry data from the data store through the appropriate transports to the consumer, 1810. Any data that fails the compliance check should not be stored, 1812.

As stated above, embodiments are generally described for security requirements linked with GDPR regulations. However, any other public or private compliance regime for any appropriate reason or application can also be supported. For example, in large scale commercial networks, the integrity of data must often meets at least one of the two broad categories of retention standards: (1) corporate governance rules and (2) government/regulatory compliance (e.g. GDPR, SEC 17a-4(f), CFTC, etc.) standards. This dictates many aspects of their processing and handling. For example, access and transmission must be strictly controlled, retention locks on such data must be in compliance to ensure that all locks are expired, or that this data is not present in any storage or archive that is meant to be deleted, and so on.

### Controlling Telemetry Producers and Consumers

In a large-scale network deployment, the number of telemetry consumers (e.g., users 402) and the number of producers (nodes/pods) can become very large. As pods are allowed to register new metrics or datasets dynamically, any lack of control over which producer can send datasets to these new metrics can lead to a situation in which duplicate and superfluous data may get collected. This produces inefficiencies, which can ultimately lead to performance degradation of the cluster network.

In an embodiment, system 200 of FIG. 2 includes a telemetry producer and consumer control process 170 as part of the dynamic telemetry process 112, and which may be used when new metrics are registered per process 117, or if new producers are added to those that produce existing metrics.

During registration of any new metric, the registering producer (pod) can provide the list of producers that are permitted to send the new metric. The names of these producers are stored in the telemetry catalog along with metric name and schema. A telemetry library is provided to the producer pods to ensure that any new data stream transmitted from a pod is validated with the catalog in telemetry collector to ensure that the pod is allowed to start such a stream. Once validated, the data stream can be started and continued by that new producer. If the producer is not allowed to start such a stream, then an error message will be returned by the telemetry library. This process allows for dynamic verification of the producing pod while creating data streams for newly registered metric datasets to allow them to be sent to users through the telemetry infrastructure.

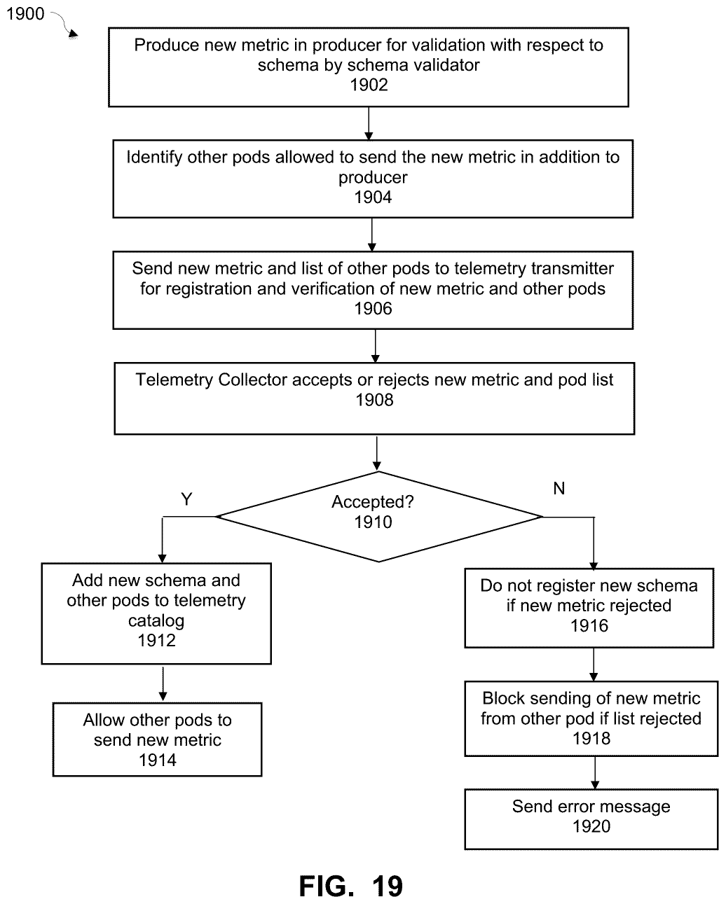

FIG. 19 is a flowchart that illustrates a method of controlling telemetry producers when registering new metrics, under some embodiments. Process 1900 of FIG. 19 begins with a producer producing a new metric for validation by the telemetry transmitter, 1902. The producer can also specify other pods to send the new metric, 1904. The producer sends the new metric and list of other pods for registration of the schema and acceptance of the other pods, 1906. A telemetry collector component in the telemetry transmitter accepts or rejects the new metric and list of other pods, 1908. If the schema and pod list are accepted (step 1910), the new schema and other pods are added to the telemetry catalog, 1912. The other pods are now able to send the metric as part of their telemetry data.

If, however, in step 1910 is the telemetry collector rejects the new schema and/or the pod list, the schema is not registered (if it the new metric that is rejected), 1916, and/or the other pods are blocked from sending the new metric (if the list of other pods is rejected), 1918. In the case of a rejected pod list, the telemetry library can return an error message to the attempting pod, 1920.

Through this process, the pool of possible telemetry data producers is controlled by preventing the generation of duplicative and superfluous telemetry data in the network by an excessive number of producers.

As with producers, in a large-scale system, as pods are allowed to register new metrics or datasets dynamically, any lack of control consumers that can access or receive these new metrics can lead to a situation in sensitive data may be improperly transmitted. This can jeopardize the integrity of the data and improperly expose confidential information and other sensitive data. For example, if a producer registers to share metrics with personally identifiable information (PII), these metrics should be received by only a limited or controlled set of consumers in the network to ensure that the data is handled in compliance with applicable regulations and guidelines, such as GDPR (General Data Protection Regulations).

In an embodiment, system 200 includes a telemetry consumer control process as part of component 170 for dynamic telemetry process 112, and may be used when new metrics are registered, or if new consumers are added to those that already receive existing metrics.

During registration of any new metric, the registering producer can provide the list of consumers or receivers that are permitted to receive the new metric. The names of these consumers are stored in the telemetry catalog along with metric name and schema. The telemetry collector, while sharing any metric with subscribed consumers, will verify the consumers using the catalog entry of the metric to determine whether or not the subscribing consumer is entitled to receive that metric. This process allows for dynamic verification of the consuming pod while producers share metrics with subscribed consumers.

Generally, a consuming pod or list of pods will be rejected if any of the listed pods is not cleared, privileged, or otherwise deemed acceptable to receive the telemetry data due to the fact that the underlying data or the telemetry data itself constitutes sensitive data. In an embodiment, such sensitive data may be data that is explicitly or implicitly subject to compliance regulation, such as due to data security concerns. This can include PII information or any data marked “confidential,” “privileged,” “secret,” “sensitive,” and so on. The system may include processes, such as compliance checks, that automatically tag and/or recognize such sensitive data, or the data may be classified or tagged as it is stored. Data that falls under GDPR regulations is an example of such data, among other similar types of data.

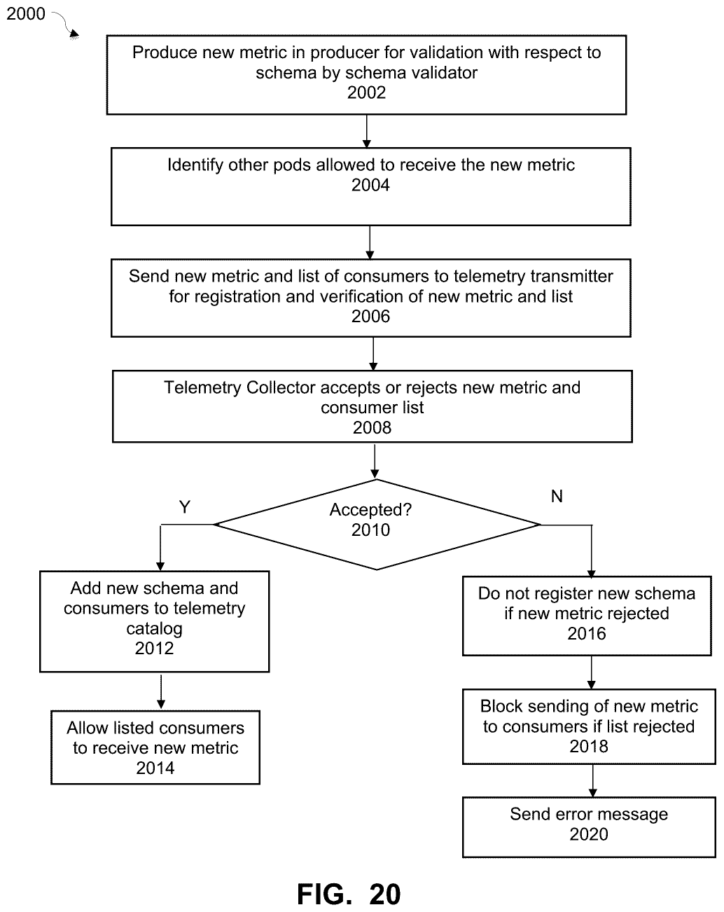

FIG. 20 is a flowchart that illustrates a method of controlling telemetry consumers when registering new metrics, under some embodiments. Process 2000 of FIG. 20 begins with a producer producing a new metric for validation by the telemetry transmitter, 2002. The producer can also specify consumers to receive the new metric, 2004. The producer sends the new metric and list of consumers for registration of the schema and acceptance of the consumer list, 2006. A telemetry collector component in the telemetry transmitter accepts or rejects the new metric and list of consumers, 2008. If the schema and consumer list are accepted (step 2010), the new schema and consumers are added to the telemetry catalog, 2012. The listed consumers are now able to receive the metric as part of the telemetry data.

If, however, in step 2010 is the telemetry collector rejects the new schema and/or the consumer list, the schema is not registered (if it the new metric that is rejected), 2016, and/or the consumers are blocked from receiving the new metric (if the list of consumers is rejected), 2018. In the case of a rejected consumer list, the telemetry library can return an error message to the producer pod, 2020.

Through this process, consumers of telemetry data are validated upon generation of metric datasets to prevent any potential unwanted exposure of sensitive information to unvetted consumers.

### Golden Signal Telemetry Data Processing for Self-Healing

Certain signals are very important for monitoring and tuning a storage system based on Kubernetes containerization technology. These signals are referred to as ‘golden signals,’ and can include (1) latency, which measures the time between the moment a service is requested and the moment it is received, (2) traffic, which measures how much activity is present in an application, (3) errors, which is the rate at which requests are failing, and (4) saturation, which is an overview of system utilization, such as indicating how much more capacity a service has, or when is the service maxed out. FIG. 8 illustrates some example golden signals, and other or additional signals may also be used depending on system configuration.

Embodiments of system 200 include a golden signal collection process 164 that works with the dynamic telemetry process 112. This process facilitates the automatic collection of golden signals in the system through a library that is added to every pod (such as through a REST handler) and which will track and share the latency, errors, traffic and saturation for every pod.

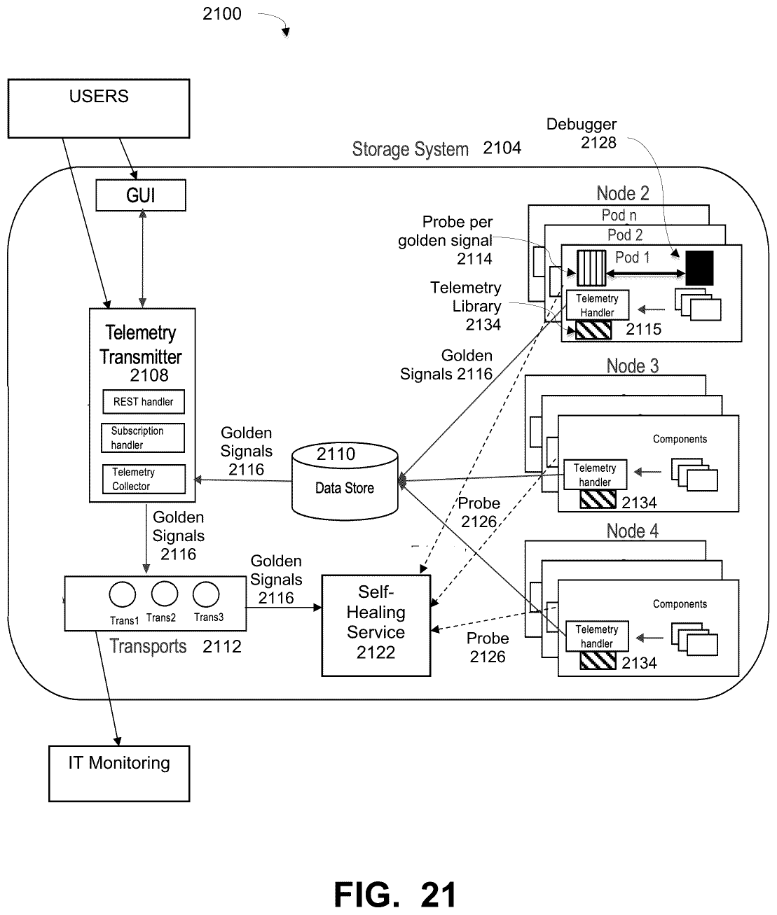

FIG. 21 illustrates a Kubernetes-based telemetry system processing golden signals, under some embodiments. As shown in FIG. 21, and similar to the system of FIG. 4, system 2100 includes a containerized storage system 2104 comprising a number of nodes (e.g., denoted Node 2, Node 3, Node 4, and so on), each having a number of pods (e.g., Pod 1 to n). Each pod has a telemetry handler component 2116 that sends telemetry data 2114 in the form of metrics to a data store 2110.

In system 2100, telemetry consumers are allowed to make dynamic subscriptions for receiving different metric datasets 2114 through one or more different transport mechanisms 2112 for which they have subscribed. Raw data from the pods is collected through their respective telemetry handlers 2116 and stored in a central data store 2110, such as through the OTEL interface. A telemetry transmitter 2108 reads data from datastore, performs any required processing and then sends the telemetry data to the consumers through the subscribed transports 2112.

For the embodiment of FIG. 21, the pods send golden signal telemetry signals 2116 to the datastore 2110 for storage. These golden signals are then transmitted as appropriate through the system to users through transports 2116. Consumers can receive golden signals per their subscription terms, as described above. In this case, golden signals are simply treated as a class of telemetry data.

A Kubernetes system may use probes to verify certain states of the containers in the system. For example, a liveness probe can be used to indicate when to restart a container, a readiness probe may be used to know when a container is ready to start accepting traffic, a startup probe may be used to know when a container application has started, and so on. For the embodiment of FIG. 21, system 2100 employs probes 2126 to implements certain self-healing processes. For this embodiment, the system does not need to restart an entire pod in the event that any issue is detect in the REST API workflows involving multiple pods. A self-healing process uses golden signals to self-heal problematic issues inside a single pod as well as error situations involving a series of pods involved in a REST API workflow of the Santorini cluster 101.

For this embodiment, golden signals 2116 are be dynamically collected for every pod and stored in the datastore 2110. The telemetry collector in the telemetry transmitter 2108 performs the golden signal collection process, as described in above embodiments. The golden signals are processed through a telemetry library 2134 provided to each pod sending gold signals.

The probes 2126 perform a system monitoring function to monitor the containers of the system, and can be configured to monitor the specific state of a pod, container, and/or individual applications housed in the containers.

The self-healing architecture of system 2100 utilizes the golden signals in combination with a self-healer pod that monitors different golden signals in relation to defined thresholds, probes that can be called by self-healer pod upon crossing a threshold value, and an intelligent debugger inside the pod for addressing issues specific to the pod. As shown in FIG. 21, Pod 1 of Node 2 illustrates an example of a self-healing pod for Node 2. This pod includes a telemetry handler 2115 comprising a REST handler, one or more probes per the golden signals 2114, and an intelligent debugger 2128. The other nodes (Node 3, Node 4) can also have similar self-healing pods, or they may utilize the self-healing pod for another node, such as Node 2.

In system 2100, every pod registers its self-healing probe per golden signal with needed details like REST endpoints, threshold values, and so on.

In an embodiment, a self-healing service 2122 is registered as a subscriber for golden signals 2116 to the telemetry collector of transmitter 2118. Whenever a self-healer pod determines that a threshold value for a golden signal is crossed for any registered pod, then respective probe will be called for self-healing through service 2122.

For every pod an intelligent debugger 2128 can be deployed that is designed to be triggered by the probes 2126. This debugger can be configured to address different types of issues as detected in the pod, depending on applications, system configuration, and so on.

Each of the golden signals can be used and probed to provide an indication of a particular problem. For example, one common reason causing latency for REST APIs is the time taken in reading/writing to a database. This could be because database is locked by some process and not released. With collection of the latency golden signal, the latency issue due to database locking can be identified and addressed through self-healing service 2122 and debugger 2128. Using the telemetry architecture with golden signal collection and self-healer pods, the latency issue for a pod workflow can be analyzed. If the issue is found to be due to database locking, the system could address by forcing a release of the database lock, offloading database processing to another node, or other remedial measures. In this way, database locking causing latency in any REST API workflow involving multiple pods can be dynamically detected and corrected using the self-healing architecture based on a latency golden signal. This is just one example of the use of a golden signal in used by Kubernetes probe features and a self-healing service. Many other examples are also possible using any of the other golden signals of traffic, errors, saturation, and so on.

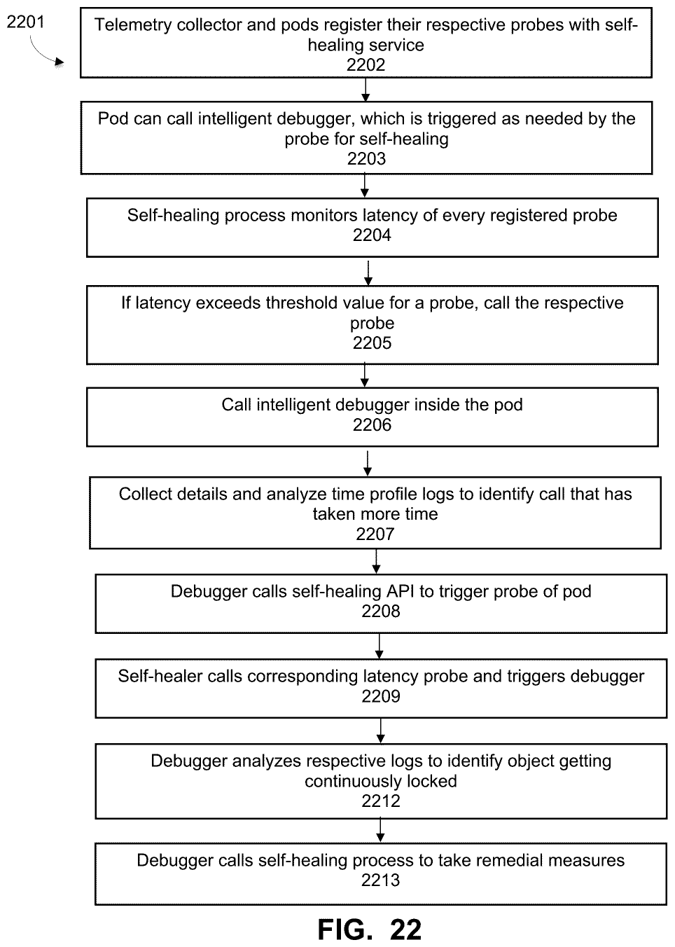

FIG. 22 is a flowchart illustrating a method of using golden signals for self-healing, under some embodiments. Process 2201 starts with the telemetry collector and pods register their respective probes with the self-healing process, 2202. For latency monitoring, this involves registering the latency probe, and the same for the other golden signals. Every pod will have a process call to an intelligent debugger, which will be triggered as needed by the probe for self-healing different pod related issues, 2203.

While registering a probe, certain parameters are specified, such as the name of the registering pod, the name of the latency probe for each pod, as well as the API endpoints and the threshold values.

As shown in step 2204 of FIG. 22, the self-healing process monitors the latency for every registered probe. When it detects a latency beyond the threshold value for a probe, will call the respective probe, 2205. For the example of FIG. 11, when the threshold for telemetry transmitter's metrics GET goes beyond 5 mins, the self-healer will call the ../telemetrytransmitter/goldensignals/latency probe.

The inside latency probe of the telemetry transmitter will then start an intelligent debugger process designed for debugging golden signal issues inside the pod, 2206. This debugger will collect details of the current threshold issue and start time profiling the REST endpoint by making a debugging call to the same REST endpoint with the same parameters. After getting response from the REST endpoint, the debugger will analyze time profile logs to find out which call has taken more time, 2207. The debugger will then call the self-healing process API to trigger a probe of the appropriate pod, 2208. For example, if the call to TimeScale database is showing more time, then it will call self-healer API to trigger a probe of TimeScale database pod.

Inside the pod identified in step 2208, the self-healer will call the corresponding latency probe, and the its intelligent debugger will be triggered to call the same API with same parameters with time profile, 2209. For the example above, the self-healer will call TimeScale database's latency probe, and inside the TimeScale database pod, the debugger will be triggered to call the same API with same parameters with time profile. The debugger will then analyze respective logs to find out database (or other data objects) that is getting continuously locked, 2212. The debugger can then call the self-healing process and report functionality, which can then take remedial measures 2213.

For an example of the TimeScale pod, the remedy can be to first use a fuser command to find out which process or processes locked the database. It can then take a backup of the database, and restart the processes locking the database. The REST API with the same parameters will then be called once again to ensure that the database is no longer locked. After this, the system vendor can be alerted and sent a message stating that the database is getting locked continuously by specific processes so that support and engineering can address any code issue in a fix or future upgrade.

Although embodiments are described and illustrated with respect to latency probes and excessive database operation latency, it should be noted that embodiments can include any probe, golden signal, and issue.

As shown in FIG. 22, a first step (step 2202) is to register probes for the golden signals with the self-healing service. In an embodiment, this registration involves validating a schema of the probes including the name and format of the probe as a data object.

In an embodiment, a catalog is used to store the list of schemas of available metrics to which consumers can subscribe. Every metric will be represented in the catalog using its schema. When new metrics get dynamically registered by any telemetry producer through a REST API, schema of these new metrics get updated to the catalog so that consumers get up-to-date catalog information for subscription.

Embodiments of the dynamic telemetry process 112 include a dynamic registration process for new metrics including probes along with the golden signals themselves. This process includes a registration method for data producers to add new data sets dynamically to the telemetry workflow. This involves making dynamic changes to the data handling procedures at multiple points, including data generation, data collection, data storing, data sharing with subscribers, and so on. The new golden signal telemetry data can be added through a process such as shown with respect to FIG. 14A. This update process is dynamic in that the new golden signals can be generated and validated with the telemetry catalog updated as needed while the cluster network is running, and consumers are alerted in real-time as to the new metric and their subscriptions can be immediately updated to include these new metrics.

### Optimizations for Streaming Telemetry Data

In some cases, the telemetry data may comprise streaming network telemetry, which is a real-time data collection service in which network devices, such as routers, switches and firewalls, continuously push data related to the network's health to a centralized location. Streaming telemetry is push-based, and data transmits automatically and continuously.

In streaming telemetry, every metric data stream is stored as a separate table maintained in a datastore. Different metric streams related to same resource create multiple in present systems, thus complicating the task of data extraction, as mentioned previously.

In an embodiment, cluster network 100 includes a dynamic telemetry process 112 that optimize data storage and network bandwidth when processing streaming data. As shown in FIG. 2, system 200 includes, within optimizations 160, a table merging process 162a that merges multiple streams from the telemetry producer for a specific data resource, and a duplicate data encoder 162b that prevents unnecessary storage of duplicative data.

With respect to the table merging process 162a, to merge the multiple streams epochs can be used to collate the data for a specific resource. As an epoch can differ for different data streams, the process can aggregate the data around time boundaries. A cache is be created for each resource to hold the data in memory until all streams associated with that resource are present in the pipeline. For the same epoch for a specific resource, metric data can be collected and stored in a new table in the datastore. In this manner, the streaming telemetry data stored for a resource will have no duplicity and will lead to easier data extraction.

In addition, if a new stream is generated for a specific resource, such as for replication throttle, the cache based on the metric information (e.g., name) allows it to be added to the existing table for a particular replication context. When the data for this application (e.g., replication throttle) arrives in the telemetry pipeline, it can be integrated within the cache alongside the replication precompression and replication network data. When the data having the new stream information is sent to the datastore, a new column will be automatically added to the existing table as per open telemetry (OTLP) processes.

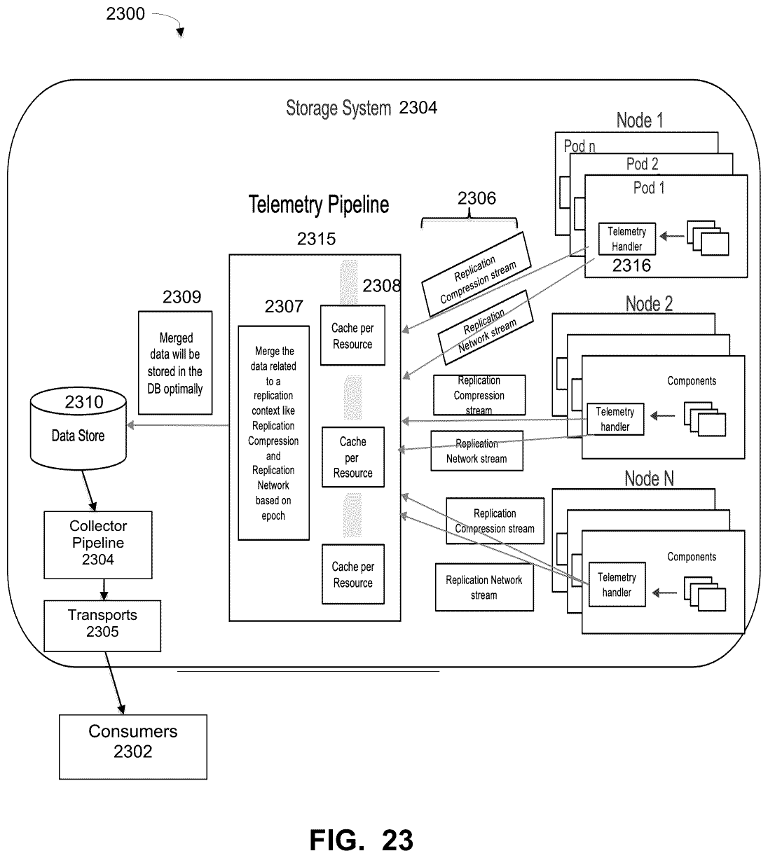

FIG. 23 illustrates a telemetry system for merging dataset tables in time-series, under some embodiments. As shown in FIG. 23, system 2300 includes a containerized storage system 2304 comprising a number of nodes (e.g., denoted Node 2, Node 3, Node 4, and so on), each having a number of pods (e.g., Pod 1 to n). Each pod has a number of components including a telemetry handler component 2316 that sends telemetry data for storage in a datastore 2310 and transmission to telemetry consumers. For the embodiment of FIG. 23, the telemetry data sent by the pods comprises streaming telemetry 2306. Various types of streaming data can be send depending on the system configuration and applications. For the example embodiment shown, the data streams comprise a replication compression stream and a replication network stream sent from each three pods. The types of data streams 2306 are shown for purposes of example only, and any other data stream may also be used.

The data streams 2315 are sent to the datastore 2310 through a telemetry pipeline 2315. The telemetry pipeline is configured to have a cache 2308 for every resource, where a resource comprises a pod (or node) transmitting streaming data from a telemetry handler 2316. Each such pod will maintain a cache 2308 that temporarily stores the data streams generated by that pod.

The cached data streams from all of the caches are periodically merged through a merge process 2307. The periodicity of the merge process is defined by an epoch, which is a measure of time during which data streams are collected from the caches for merging with each other. For the example of FIG. 23, the merge process 2307 merges telemetry data related to a replication operation for the replication compression stream and replication network stream for each pod. Once merged, the telemetry data will be stored through process 2309 in the datastore 2310, such as in a database or other similar data element.

Once stored, the merged telemetry can be processed and transmitted from the storage system as needed. For the example of FIG. 23, the telemetry data is collected by a telemetry collector in a collector pipeline 2304. It is then sent by a transport mechanism 2305 out to one or more consumers. The transport mechanisms may comprise Webhook, SMTP, SNMP, or other similar mechanisms. The data consumers 2302 can be GUIs, internal pods, storage vendor IT backend systems, or storage system users, among others. The streaming data from the data store 2310 from the pods is collected through a collector pipeline through the respective telemetry handlers 2316, and then transmitted through a selected transport mechanism 2305 to the consumers.

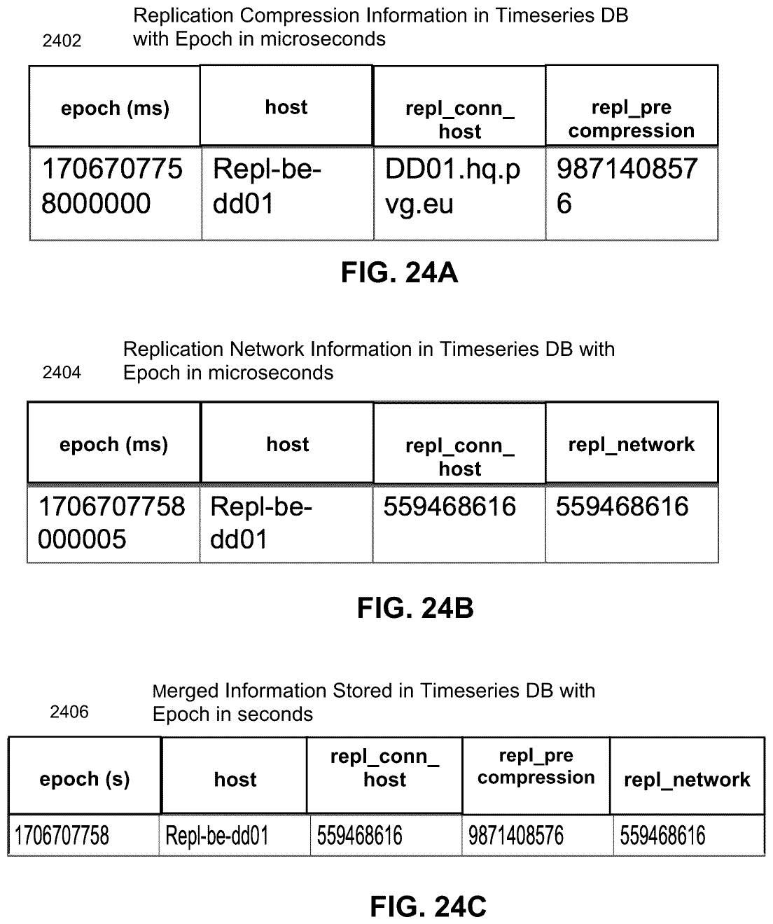

Process 2307 merges the multiple streams of the producers into one stream for storage as a single table or database. FIGS. 24A, 24B, and 24C illustrate an example of a two tables merged to form a stored table, under an example embodiment. FIG. 24A illustrates information for a replication compression data stream in a time series database 2402 with an epoch on the order of microseconds. The information comprises the epoch (ms), the hostname, the replication connection host (repl_conn_host), and the replication precompression data.

FIG. 24B illustrates information for a replication network information data stream in a time series database 2404, also with an epoch on the order of microseconds. The information comprises the epoch (ms), the hostname, the replication connection host (repl_conn_host), and the replication network data.

These two tables 24A and 24B, are merged to create the time-series database 2406. In this case, the epoch is on the order of seconds to capture both datasets of tables 2402 and 2404, which have different epochs in the micro-second scale. As shown in FIG. 24C, the merged time-series database 2406, has the same host as both table 2402 and 2404, and database entries for each of the replication precompression data and the replication network data. It should be noted that FIG. 24 is provided for purposes of example only, and other datasets, network elements, and time epochs may also be used.

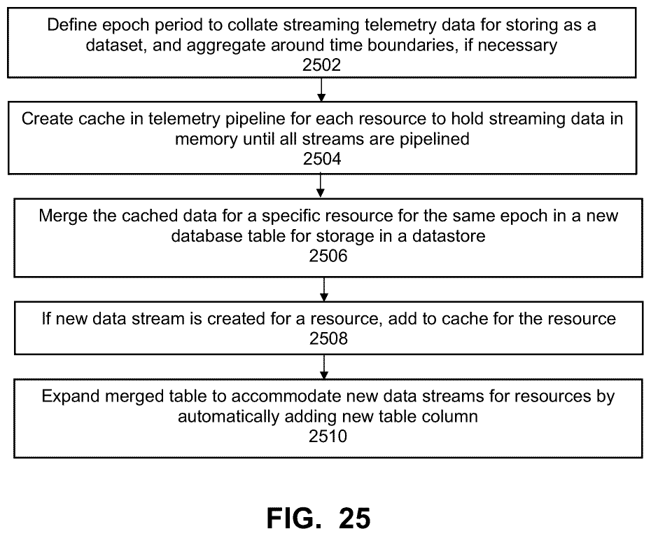

FIG. 25 is a flowchart illustrating a method of creating and merging streaming telemetry data, under some embodiments. The process of FIG. 25 begins with defining the epoch period to collate the streaming telemetry data for each resource for storing as a dataset, 2502. The epoch periods are typically on the order of microseconds to full seconds or minutes, depending on the type of telemetry data produced. Epochs can differ for different data streams so the data can be aggregated around time boundaries, if necessary.

A cache is created in the telemetry pipeline for each resource to hold the data in memory until all streams associated with that resource are present in the pipeline, 2504. the process then merges the cached data for a specific resource for the same epoch in a new database table for storage in a datastore, 2506. If necessary, the epoch for the merged table may be modified to accommodate the individual cached data epochs.

If a new data stream is added for a resource, that data is stored in the cache created for that resource, 2508. The merged table is then expanded to accommodate this new data stream by automatically adding a new table column to the database, 2510.

In this manner, the merged database stores all of the streaming telemetry data for the different resources in a way that eliminates any duplicate data. This ultimately provides easier extraction of telemetry data from the database as search times are reduced due to more efficient data storage.

With respect to component 162b of FIG. 2, as part of the streaming telemetry data sent as time-series datasets, the components can and often do send the same numeric and non-numeric data repeatedly, and this can generally consume a lot of network bandwidth.

Incremental data transfers, such as in data backups where only changed data is transferred, is a known concept. But the incremental/differential approaches used for incremental backups cannot be used for time series data sets. With respect to the OTEL standard, currently, only gauge, sum, counter and histogram are the supported data instruments available in time-series streams.

In an embodiment, component 162b implements a new data instrument referred to as ‘change’ to include the delta for both numeric and non-numeric data sets sent during periodic epochs. The system uses this new data instrument to encode the same data values as in a previous instance for the telemetry data to prevent or reduce transmission of non-changed datasets.

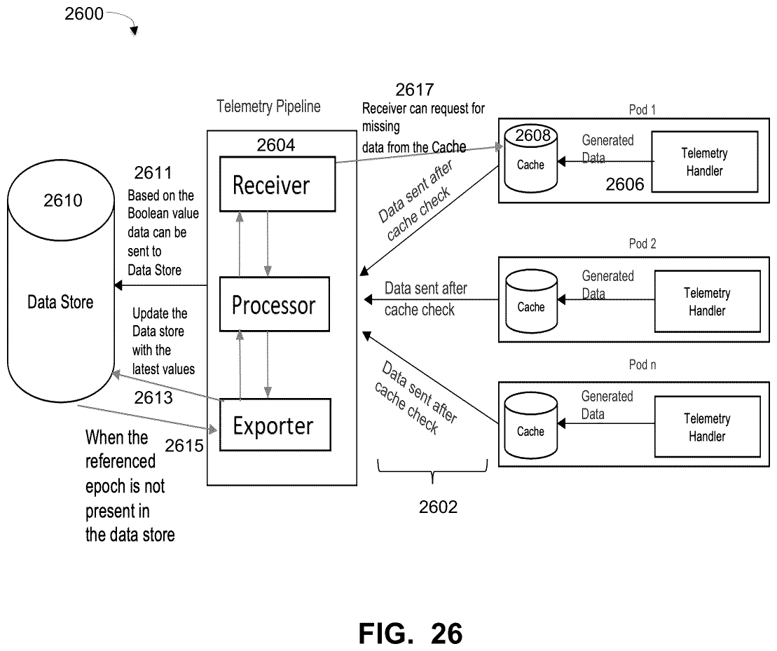

FIG. 26 illustrates a telemetry system for encoding same data in streaming telemetry data, under some embodiments. As shown in FIG. 26, system 2600 includes a containerized storage system 2600 comprising a number of pods. Each pod has a number of components including a telemetry handler component 2606 that generates streaming telemetry data as a time-series datasets for storage in a datastore 2610 and transmission to telemetry consumers. Each pod also contains a cache 2608 that is used to temporarily stores the data streams generated by that pod for checking for the presence of changed data. After the cache check, the data is sent by the pods to a telemetry collector comprising a telemetry pipeline 2604. The telemetry pipeline has receiver, processor and exporter components, among others, for transmitting the data to the data store 2610.

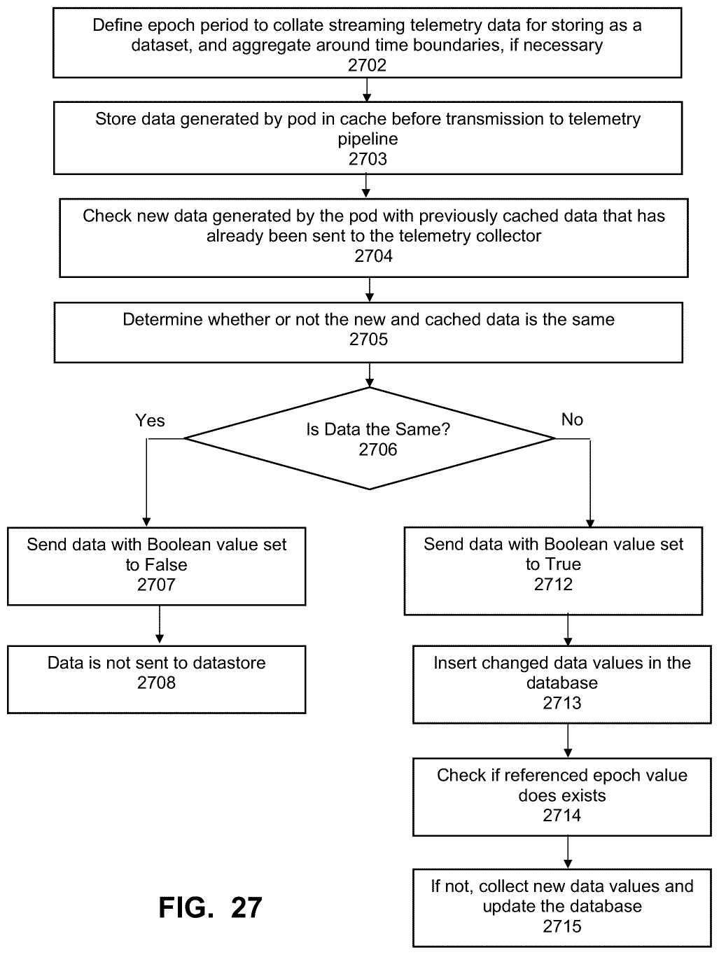

FIG. 27 is a flowchart that illustrates a process of encoding unchanged data in streaming telemetry data, under some embodiments. The process steps of FIG. 27 are generally described in conjunction with system 2600 of FIG. 26. The process of FIG. 27 begins with defining the epoch period to collate the streaming telemetry data for each resource for storing as a dataset, 2702. As stated above, the epoch periods are typically on the order of microseconds to full seconds or minutes, depending on the type of telemetry data produced. Epochs can differ for different data streams so the data can be aggregated around time boundaries, if necessary.

In step 2703, the data generated by a pod to be sent to the telemetry collector is first stored in the resident cache (e.g., 2608). When the new data is generated by the component it can be checked with the cache data which is the data that is already sent to the collector, 2704.

In step 2705, it is determined whether or not the new and cached data is the same. If, in step 2705, it is determined that the new data exactly matches the cached data, then per decision block 2705, a Boolean value set to False is sent for all the data fields with the referenced epoch, step 2707. When the consumer parses the data values, it interprets the Boolean value of False to be a lagging operation for the referenced epoch, and this data is not sent to the datastore, 2708.

If, on the other hand, it is determined in step 2706 that some of the data values between the new and cached data do not match, the new data values are transmitted with the Boolean value set as True, 2712. When the consumer parses that data for the current epoch for which the Boolean values which are set to True, there should be a lagging operation and the changed values of the new entries can be inserted into the database, 2713.

In certain cases, one of the metrics related to the referenced epoch may be missed. In cases where the data comes with the Boolean value set to True, a check should be made if the referenced epoch exists, 2714. If the referenced epoch value does not exist, then a request should be made to the telemetry collector to collect the new data values for the current epoch and update the database with the new values, and the current epoch can be set as new referenced epoch, 2715.

The process needs to rebase the data values that are collected and update the referenced epoch. This can be done periodically per a defined policy, such as once a day or once a week. Alternatively, this can be a tunable parameter in the telemetry handler in the pod.

In cases when an attribute value is not collected by the telemetry collector, it's Boolean value can be set as NULL.

With reference back to FIG. 26, the example of system 2600 illustrates data 2602 sent to the telemetry pipeline 2604. Based on the Boolean value of True or False, the data can be sent to the datastore 2610, as shown in step 2611. An exact duplicate of the data will result in a False Boolean, and the data will not be stored, while a difference in the data will result in the different data being stored. When new (i.e., different) data is stored in the database, an exporter component of the telemetry pipeline updates the datastore with the latest data values, step 2613.

As shown in step 2714 of FIG. 27, a check is made if the referenced epoch exists, step 2715. If the referenced epoch value does not exist, the receiver of the telemetry pipeline requests the missing data from the cache, step 2717.

Embodiments thus help in optimizing the network bandwidth by preventing the telemetry producers from sending duplicate numeric as well as non-numeric time series data. For a partially changing time series metric, a certain percentage (e.g., 50%) of the data (i.e., the repeating data) will not be sent. By ensuring a notification is sent from the pod regardless of whether data is duplicate or not, this acts as a heartbeat check between datastore and the telemetry handler in the pod.

The optimizations for the streaming (time-series) telemetry data may be used in a subscription-based telemetry system for Kubernetes-based networks. For this embodiment, system 500, provides certain processes that allow telemetry consumers and producers to make dynamic subscriptions (such as through process 166 of FIG. 2) to produce or consume different metric datasets 506 through one or more different transport mechanisms 505 for which they have subscribed. Such a subscription process utilizes a telemetry catalog is used to store the list of schemas of available metrics to which consumers can subscribe. Every dataset metric will be represented in the catalog using its schema. When new metrics get dynamically registered by any telemetry producer through a REST API, schema of these new metrics get updated to the catalog so that consumers get up-to-date catalog information for subscription.

As described above, in an embodiment, system 100 includes certain processes that may be implemented as a computer implemented software process, or as a hardware component, or both. As such, it may include executable modules executed by the one or more computers in the network, or embodied as a hardware component or circuit provided in the system.

Although certain embodiments have been described and illustrated with respect to certain example network topographies and node names and configurations, it should be understood that embodiments are not so limited, and any practical network topography is possible. Network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers.

Unless the context clearly requires otherwise, throughout the description and the claims, the words “comprise,” “comprising,” and the like are to be construed in an inclusive sense as opposed to an exclusive or exhaustive sense. Words using the singular or plural number also include the plural or singular number respectively. Additionally, the words “herein,” “hereunder,” “above,” “below,” and words of similar import refer to this application as a whole. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments.

What is claimed is:

1. A method of processing telemetry data in a cluster network having a plurality of nodes, comprising:
receiving telemetry data from a plurality of telemetry producers, wherein the received telemetry data is formatted into a structured format for storage in a central datastore, wherein the telemetry data can be previously generated data or new data;
validating one or more consumers of respective datasets of the telemetry data in the network, wherein the one or more consumers subscribe to receive the respective data through a subscription process; and
transmitting the respective data to subscribed consumers through a selected transport mechanism.

2. The method of claim 1 wherein the telemetry data comprises data generated periodically by each producer upon operation in the cluster network, and wherein the telemetry data comprises performance data, topology information, alerts, security states, and service features, and can comprise discrete datasets or streaming telemetry data, and further wherein the one or more consumers comprises at least one of: pod components of the nodes, storage users, graphical user interfaces (GUI), and storage vendors.

3. The method of claim 2 further comprising:
receiving a schedule to receive the telemetry data on an individual basis from one or more consumers of respective data of the telemetry data in the network; and
transmitting the respective data to the one or more consumers through a selected transport mechanism and at a respective frequency based on the received schedule.

4. The method of claim 2 further comprising:
verifying a datatype of telemetry data generated by a producer as corresponding to processed data requiring compliance with a defined regulation;
loading data compliance rules in a checklist of a telemetry transmitter;
installing the checklist in a compliance library maintained in each pod of the plurality of pods;
checking the telemetry data transmitted from the pod against a respective compliance library to determine if the telemetry data is compliant or non-compliant; and
transmitting compliant data to a datastore for storage and collection by a telemetry collector of a telemetry transmitter, and preventing storage of non-compliant data.

5. The method of claim 2 further comprising defining privileges of users to receive the metric datasets based on role-based access control (RBAC) rules derived from a hierarchy of levels of users in an organization using the network, and utilizing an identity and access manager (IAM) service.

6. The method of claim 2 further comprising:
storing schema of telemetry data generated as metric datasets by telemetry producers in the network in a telemetry catalog;
receiving, by a telemetry transmitter component, a list of other producers in addition to an original producer of a metric dataset from the original producer;
first validating the other producers to allow them to store and transmit the metric dataset;
transmitting a validation to a telemetry library of the original and other producers; and
accepting the metric dataset from the original and other producers for storage and transmission to telemetry consumers.

7. The method of claim 2 further comprising:
storing the telemetry data as generated by telemetry producers in the network in a datastore as metric datasets having a defined schema;
receiving a new metric schema for a new telemetry metric generated by a producer;
validating the new metric schema in a schema validator component of a telemetry transmitter;
storing the validated new metric schema in a telemetry catalog; and
storing a new telemetry metric dataset for the new telemetry metric in the datastore for transmission to appropriate telemetry consumers.

8. The method of claim 2 further comprising:
storing schema of telemetry data generated as metric datasets by telemetry producers in the network in a telemetry catalog;
receiving, by a telemetry transmitter component, a list of consumers selected to receive metric dataset from a producer;
first validating the consumers to allow them receive to the metric dataset;
transmitting a validation of the consumer to a telemetry library of the producer; and
sending the metric dataset from the producer to the consumers as part of the telemetry data.

9. The method of claim 2 further comprising:
storing the telemetry data as generated by telemetry producers in the network in a datastore as metric datasets having a defined schema;
defining a short-term metric as a metric to be collected for a short duration;
registering the short-term metric with a metric schema, defined duration, and condition for triggering collection of the metric;
initiating, upon detection of the condition, collection of the short-term metric; and
stopping collection of the metric at the end of the defined duration.

10. The method of claim 2 wherein the cluster network comprises a Kubernetes-based cluster network having a plurality of nodes and pods by processing golden signal telemetry data, the method comprising:
first registering, with a telemetry transmitter, a golden signal comprising telemetry data related to one of traffic, latency, errors, and saturation in storage system of the network by naming a registering pod, a probe name, an endpoint, and a threshold value;
second registering, with a self-healing service, a probe for the golden signal with the telemetry transmitter;
monitoring, by the self-healing service, an activity related to the golden signal in comparison with a respective threshold value; and
calling the registered probe when an activity value exceeds the respective threshold value as an indication of a problem condition.

11. The method of claim 2 further comprising optimizing processing of the streaming data by:
defining an epoch collating the streaming data into datasets;
merging data tables storing datasets for the epoch for a plurality of producers to optimize storage space; and
detecting identical data sent by the plurality of producers for the epoch and preventing storage of the identical data to optimize network bandwidth.

12. The method of claim 2 wherein the cluster network implements an Open Telemetry (OTEL) protocol, and comprises a collector receiving the telemetry data through a remote procedure call (RPC) process, and further wherein cluster network includes nodes each containing a plurality of pods performing network functions and generating the telemetry data for transmission to the users.

13. The method of claim 12 wherein the cluster network comprises a Santorini network processing containerized data utilizing a Kubernetes-based framework, and further wherein the plurality of nodes each contain a plurality of pods performing network functions and generating the telemetry data for transmission to the subscribing consumers.

14. A system for processing telemetry data in a cluster network having a plurality of nodes, comprising:
a telemetry collector receiving telemetry data from a plurality of telemetry producers, wherein the received telemetry data is formatted into a structured format for storage in a central datastore, wherein the telemetry data can be previously generated data or new data;
a telemetry transmitter validating one or more consumers of respective datasets of the telemetry data in the network, wherein the one or more consumers subscribe to receive the respective data through a subscription process; and
a pipeline transmitting the respective data to subscribed consumers through a selected transport mechanism, wherein the telemetry data comprises data generated periodically by each producer upon operation in the cluster network, and wherein the telemetry data comprises performance data, topology information, alerts, security states, and service features, and can comprise discrete datasets or streaming telemetry data, and further wherein the one or more consumers comprises at least one of: pod components of the nodes, storage users, graphical user interfaces (GUI), and storage vendors, and wherein the collector receives a schedule to receive the telemetry data on an individual basis from one or more consumers of respective data of the telemetry data in the network, and transmits the respective data to the one or more consumers through a selected transport mechanism and at a respective frequency based on the received schedule.

15. The system of claim 14 further comprising a security component verifying a datatype of telemetry data generated by a producer as corresponding to processed data requiring compliance with a defined regulation, loading data compliance rules in a checklist of a telemetry transmitter, installing the checklist in a compliance library maintained in each pod of the plurality of pods, checking the telemetry data transmitted from the pod against a respective compliance library to determine if the telemetry data is compliant or non-compliant, and transmitting compliant data to a datastore for storage and collection by a telemetry collector of a telemetry transmitter, and preventing storage of non-compliant data.

16. The system of claim 14 further comprising and access control component defining privileges of users to receive the metric datasets based on role-based access control (RBAC) rules derived from a hierarchy of levels of users in an organization using the network, and utilizing an identity and access manager (IAM) service.

17. The system of claim 14 wherein the telemetry data comprises golden signals related to traffic, latency, errors, and saturation in storage system of the network during execution of the backup operation, the system further comprising:
an telemetry pipeline receiving a selection of golden signal metric datasets from a consumer with a specified transport mechanism;
a telemetry transmitter subscribing the consumer in the network to golden signal receive the metric datasets through validation of a schema conforming to a structured format defined by a telemetry transmitter, and validating a schema of each golden signal metric dataset based on the structured format, and registering a latency golden signal measuring a time between a moment a data protection operation is requested and when it is initiated, by storing a registering pod identifier, a latency probe identifier, and endpoint, and a threshold value;
a latency probe detecting when the threshold value is exceeded by an operation generating the golden signal indicating a problem with the operation; and
a self-healing process component configured to identify and debug the problem with the operation.

18. The system of claim 14 further comprising an optimizer component optimizing processing of the streaming data by:
defining an epoch collating the streaming data into datasets;
merging data tables storing datasets for the epoch for a plurality of producers to optimize storage space; and
detecting identical data sent by the plurality of producers for the epoch and preventing storage of the identical data to optimize network bandwidth.

19. The system of claim 14 further comprising:
a datastore storing the telemetry data as generated by telemetry producers in the network in a data store as metric datasets having a defined schema;
an interface receiving a new metric schema for a new telemetry metric generated by a producer;
a schema validator component of a telemetry transmitter validating the new metric schema;
a telemetry catalog storing the validated new metric schema; and
a data store storing a new telemetry metric dataset for the new telemetry metric in the datastore for transmission to appropriate telemetry consumer by the telemetry transmitter.

20. A system for processing telemetry data in a cluster network having a plurality of nodes, comprising:
a telemetry collector registering producers and consumers based on defined schema of the telemetry data;
an access control component restricting access to the telemetry data based on role-based access controls (RBAC);
a security control component restrict production and use based on compliance regulations regarding security and restricted use of the telemetry data;
a self-healing component detecting generation of telemetry data in excess of defined thresholds of normal operation for one or more defined golden signal metric datasets;
an optimizer component optimizing processing of streaming time-series telemetry data with respect to data storage and network bandwidth usage; and
a datastore storing a telemetry catalog accessed by the telemetry collector and storing schema definitions for new and existing telemetry data for registering the producers, consumers, and telemetry datasets; and
a pipeline transmitting the telemetry datasets to validated consumers through selected transport mechanisms.
